(19) United States
(12) Patent Application Publication
(10) Pub. No.: US 2025/0162279 A1
(43) Pub. Date: May 22, 2025

(54) MULTILAYER SHEET, METHOD FOR PREPARING SAME, AND MULTILAYER ELECTRONIC DEVICE INCLUDING SAME

(71) Applicants: SK microworks solutions Co., Ltd., Cheonan-si (KR); SK microworks Co., Ltd., Suwon-si (KR)

(72) Inventors: Seok-Jong WOO, Cheonan-si (KR); Jun-Ki PARK, Cheonan-si (KR); Hyung-Woo CHO, Cheonan-si (KR); Kwangho JANG, Suwon-si (KR); Kweonhyung HAN, Suwon-si (KR)

(73) Assignees: SK microworks solutions Co., Ltd., Cheonan-si (KR); SK microworks Co., Ltd., Suwon-si (KR)

(21) Appl. No.: 19/033,577

(22) Filed: Jan. 22, 2025

Related U.S. Application Data
(63) Continuation of application No. PCT/KR2023/009107, filed on Jun. 29, 2023.

(30) Foreign Application Priority Data
Jul. 22, 2022 (KR) 10-2022-0091016

(51) Int. Cl. B32B 7/12; B32B 7/06; B32B 27/28; B32B 27/34

(52) U.S. Cl. CPC B32B 7/12; B32B 7/06; B32B 27/285; B32B 27/34; B32B 2307/546; B32B 2307/584; B32B 2307/7376; B32B 2457/20

(57) ABSTRACT

The multilayer sheet of the present disclosure includes an elastic layer and an adhesive layer disposed on a surface of the elastic layer, wherein a storage modulus of the multilayer sheet measured at 20° C. is 10 MPa to 2,000 MPa.

### CROSS-REFERENCE TO RELATED APPLICATIONS

Pursuant to 35 USC 120 and 365(c), this application is a continuation of International Application No. PCT/KR2023/009107 filed on Jun. 29, 2023, and claims the benefit under 35 USC 119(a) of Korean Application No. 10-2022-0091016 filed on Jul. 22, 2022, in the Korean Intellectual Property Office, the entire disclosure of which is incorporated herein by reference for all purposes.

### BACKGROUND

### 1. Field

The present disclosure relates to a multilayer sheet for protection of a display or the like and a multilayer electronic device including the same.

### 2. Description of Related Art

As mobile devices, such as mobile phones, smartphones, and tablets, and information processing terminals, such as ATMs and kiosks, are diversified, surface protection sheets are being used in various ways. In addition, as various types of display devices, such as a foldable display device, a flexible display device, and a rollable display device, have developed, it is necessary to achieve sufficient durability for repeated folding, rolling, etc., along with the requirements for surface hardness to inhibit scratches on the surfaces thereof. In addition, optical properties are required, when these protection sheets applied to display screens.

### SUMMARY

In one general aspect, the multilayer sheet according to an embodiment of the present disclosure includes an elastic layer and an adhesive layer disposed on a surface of the elastic layer, wherein a storage modulus of the multilayer sheet measured at 20° C. is 10 MPa to 2,000 MPa.

The RSM (Relative Storage Modulus) value of the multilayer sheet measured at 20° C. according to Equation 1 below may be 1 to 200:

RSM=SME/SMB [Equation 1]

In the Equation 1, SME is a storage modulus of the elastic layer and SMB is a storage modulus of the adhesive layer.

An absolute value of the storage modulus of the multilayer sheet measured at 20° C. minus a storage modulus value of the multilayer sheet measured at 60° C. may be 1,000 MPa or less.

An absolute value of a storage modulus value of the multilayer sheet measured at −40° C. minus the storage modulus value of the multilayer sheet measured at 20° C. may be 1,500 MPa or less.

A storage modulus of the elastic layer measured at 20° C. may be 10 MPa to 3,000 MPa.

A storage modulus of the adhesive layer measured at 20° C. may be 1 MPa to 50 MPa.

An adhesive force of the adhesive layer after curing may be 2 N/inch or more.

An adhesive force per unit thickness (1 μm) of the adhesive layer after curing may be 0.8 N/inch or more.

A thickness of the multilayer sheet may be 10 μm or more.

The multilayer sheet may further include an additional adhesive layer disposed on another surface of the elastic layer opposite to the surface of the elastic layer.

The multilayer sheet may further include a transparent layer disposed on the adhesive layer and a coating layer disposed on the transparent layer.

The multilayer sheet may further include a release film disposed on a surface of the adhesive layer.

The release film may include a release layer disposed on the surface of the adhesive layer and a release base layer disposed on a surface of the release layer.

The elastic layer may include polyether block amide including a rigid region and a soft region comprising polyether.

The adhesive layer may be selected from the group consisting of an acrylic-based adhesive layer, a urethane-based adhesive layer, and a silicone-based adhesive layer.

The adhesive layer may be a silicone-based adhesive layer.

A thickness of the adhesive layer may be more than 1 μm.

In another general aspect, the method of preparing a multilayer sheet includes: preparing an elastic layer; and laminating an adhesive layer on the elastic layer, wherein the adhesive layer is prepared by: drying a silicone adhesive composition on the elastic layer to form a precursor layer; and curing the precursor layer to form the adhesive layer.

The silicone adhesive composition may include a silicone adhesive, a catalyst, and a solvent.

In still another general aspect, the multilayer electronic device according to another embodiment of the present disclosure includes the multilayer sheet and a light emitting functional layer disposed under the multilayer sheet.

### BRIEF DESCRIPTION OF THE DRAWINGS

FIG. 1 is a conceptual view illustrating the multilayer sheet according to an embodiment of the present disclosure.

FIG. 2 is a conceptual view illustrating the multilayer sheet according to another embodiment of the present disclosure.

FIG. 3 is a conceptual view illustrating the multilayer sheet according to yet another embodiment of the present disclosure.

FIG. 4 is a conceptual view illustrating the multilayer sheet according to yet another embodiment of the present disclosure.

FIG. 5 is a conceptual view illustrating the multilayer electronic device according to a further embodiment of the present disclosure.

FIGS. 6 to 12 are graphs showing storage modulus measurements depending on temperature in examples and comparative examples.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

As used herein, the terms “about,” “substantially,” and the like are intended to be used at or near the numerical value when preparation and material tolerances inherent in the mentioned meaning are presented and to prevent unscrupulous infringers from taking unfair advantage of the disclosure where precise or absolute numerical values are stated in order to aid in the understanding of the embodiments.

Throughout this disclosure, the term “combination thereof” as used in a Markush-style representation is intended to mean at least one mixture or combination selected from the group of components described in the Markush-style representation, including one or more selected from the group of components.

Throughout this disclosure, references to “A and/or B” mean “A, B, or A and B”.

Throughout this disclosure, terms such as “first” and “second” or “A” and “B” are used to distinguish one from another unless otherwise indicated.

In this disclosure, reference to B being located on A means that B may be located on A or that B may be located on A in the state in which another layer is interposed therebetween, and is not be construed to be limited to B being located on A in surface contact therewith.

In this disclosure, singular expressions are construed to include singular forms or plural forms as interpreted from the context unless otherwise indicated.

A resin as described herein is interpreted to include the resin itself and a compound derived from the resin. For example, a polyester resin as described herein means the polyester resin and a derivative of the polyester resin.

In the present disclosure, when an adhesive layer is a curable adhesive layer, the storage modulus value of the adhesive layer corresponds to a value measured from the cured adhesive layer.

In the present disclosure, when an adhesive layer included in a multilayer sheet is a curable adhesive layer, the storage modulus value of the multilayer sheet corresponds to a value measured from the multilayer sheet after curing the adhesive layer in the multilayer sheet.

An object of embodiments is to provide a multilayer sheet configured such that peeling of the multilayer sheet from the surface of an attachment target is inhibited even though bending or rolling is repeated over a wide temperature range, interlayer separation does not occur, and the multilayer sheet is resistant to external impact.

The inventors of the present disclosure have controlled the storage modulus value of a multilayer sheet including an elastic layer and an adhesive layer. As a result, the inventors have experimentally confirmed that, when the multilayer sheet is attached to a flexible attachment target such as a flexible display, the multilayer sheet is not separated from the surface of the attachment target even when the attachment target is repeatedly bent or rolled, and the multilayer sheet can reliably protect the attachment target, and have completed the embodiments.

Therefore, the multilayer sheet of the present disclosure is characterized in that peeling of the multilayer sheet from the surface of an attachment target is inhibited even though bending or rolling is repeated over a wide temperature range, interlayer separation does not occur, and the multilayer sheet is resistant to external impact.

Hereinafter, the present disclosure will be described in detail.

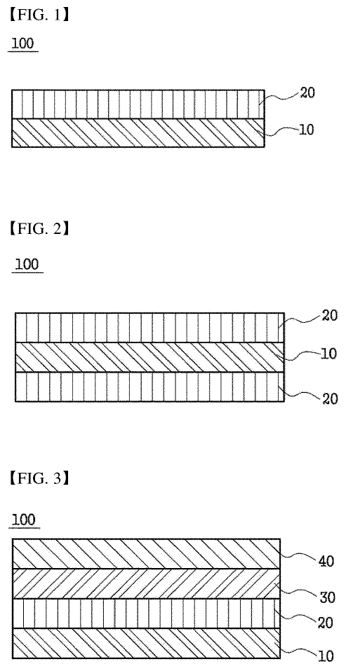

FIG. 1 is a conceptual sectional view illustrating the structure of the multilayer sheet according to the present disclosure. The multilayer sheet of the present disclosure will be described in more detail with reference to FIG. 1.

The multilayer sheet 100 of the present disclosure includes an elastic layer 10 and an adhesive layer 20 disposed on the elastic layer 10.

### Multilayer Sheet

The storage modulus of the multilayer sheet 100 measured at 20° C. may be 10 MPa to 2000 MPa.

In the present disclosure, it is possible to control the storage modulus measured at specific temperature of the multilayer sheet 100 to be within a range predetermined by the present disclosure. In this case, the modulus difference value between a flexible display having a relatively high storage modulus value and the multilayer sheet 100 may be reduced. This may effectively inhibit peeling of the multilayer sheet 100 attached to the display from the surface of the display due to repeated bending. In addition, it is possible to reliably protect the display from external impact.

The measurement temperature-specific storage modulus of the multilayer sheet 100 is measured in accordance with ASTM D4065. Specifically, the measurement temperature-specific storage modulus of the multilayer sheet 100 is measured using a viscoelastic measuring device by applying a temperature increase rate of 5° C./min within a temperature range of −50° C. to 100° C.

For example, the storage modulus may be measured using a model DMA7100 from Hitachi.

The storage modulus of the multilayer sheet 100 measured at 20° C. may be 10 MPa to 2,000 MPa. The storage modulus value may be 20 MPa or more. The storage modulus value may be 50 MPa or more. The storage modulus value may be 100 MPa or more. The storage modulus value may be 200 MPa or more. The storage modulus value may be 300 MPa or more. The storage modulus value may be 1,800 MPa or less. The storage modulus value may be 1,500 MPa or less. The storage modulus value may be 1,200 MPa or less. The storage modulus value may be 1,000 MPa or less. When attached to a flexible display, the multilayer sheet may be reliably attached to the surface of the display despite repeated bending of the display.

The storage modulus of the multilayer sheet 100 measured at 0° C. may be 20 MPa to 2,500 MPa. The storage modulus value may be 30 MPa or more. The storage modulus value may be 40 MPa or more. The storage modulus value may be 100 MPa or more. The storage modulus value may be 200 MPa or more. The storage modulus value may be 350 MPa or more. The storage modulus value may be 2,000 MPa or less. The storage modulus value may be 1,500 MPa or less. The storage modulus value may be 1,000 MPa or less. The storage modulus value may be 700 MPa or less.

The storage modulus of the multilayer sheet 100 measured at −20° C. may be 30 MPa to 3,000 MPa. The storage modulus value may be 50 MPa or more. The storage modulus value may be 100 MPa or more. The storage modulus value may be 200 MPa or more. The storage modulus value may be 300 MPa or more. The storage modulus value may be 400 MPa or more. The storage modulus value may be 2,500 MPa or less. The storage modulus value may be 2,000 MPa or less. The storage modulus value may be 1,500 MPa or less. The storage modulus value may be 1,000 MPa or less. The storage modulus value may be 700 MPa or less.

The storage modulus of the multilayer sheet 100 measured at −40° C. may be 50 MPa to 4,000 MPa. The storage modulus value may be 100 MPa or more. The storage modulus value may be 200 MPa or more. The storage modulus value may be 300 MPa or more. The storage modulus value may be 400 MPa or more. The storage modulus value may be 500 MPa or more. The storage modulus value may be 3,500 MPa or less. The storage modulus value may be 3,000 MPa or less. The storage modulus value may be 2,500 MPa or less. The storage modulus value may be 2,000 MPa or less. The storage modulus value may be 1,500 MPa or less. The storage modulus value may be 1,000 MPa or less. The storage modulus value may be 600 MPa or less.

The storage modulus of the multilayer sheet 100 measured at 40° C. may be 5 MPa to 2,000 MPa. The storage modulus value may be 10 MPa or more. The storage modulus value may be 20 MPa or more. The storage modulus value may be 50 MPa or more. The storage modulus value may be 100 MPa or more. The storage modulus value may be 150 MPa or more. The storage modulus value may be 1,500 MPa or less. The storage modulus value may be 1,200 MPa or less. The storage modulus value may be 1,000 MPa or less. The storage modulus value may be 800 MPa or less. The storage modulus value may be 700 MPa or less.

The storage modulus of the multilayer sheet 100 measured at 60° C. may be 3 MPa to 800 MPa. The storage modulus value may be 10 MPa or more. The storage modulus value may be 20 MPa or more. The storage modulus value may be 50 MPa or more. The storage modulus value may be 80 MPa or more. The storage modulus value may be 100 MPa or more. The storage modulus value may be 600 MPa or less. The storage modulus value may be 400 MPa or less. The storage modulus value may be 300 MPa or less.

The storage modulus of the multilayer sheet 100 measured at 80° C. may be 1 MPa to 500 MPa. The storage modulus value may be 5 MPa or more. The storage modulus value may be 10 MPa or more. The storage modulus value may be 30 MPa or more. The storage modulus value may be 50 MPa or more. The storage modulus value may be 400 MPa or less. The storage modulus value may be 300 MPa or less. The storage modulus value may be 250 MPa or less. The storage modulus value may be 200 MPa or less.

In these cases, the multilayer sheet may be reliably attached to the flexible display over a wide temperature range.

The absolute value of the storage modulus value of the multilayer sheet 100 measured at 20° C. minus the storage modulus value of the multilayer sheet 100 measured at 40° C. may be 700 MPa or less. The absolute value may be 500 MPa or less. The absolute value may be 300 MPa or less. The absolute value may be 100 MPa or less. The absolute value may be 50 MPa or less. The absolute value may be 20 MPa or less. The absolute value may be 10 MPa or less. The absolute value may be 1 MPa or more.

The absolute value of the storage modulus value of the multilayer sheet 100 measured at 20° C. minus the storage modulus value of the multilayer sheet 100 measured at 60° C. may be 1,000 MPa or less. The absolute value may be 700 MPa or less. The absolute value may be 500 MPa or less. The absolute value may be 300 MPa or less. The absolute value may be 100 MPa or less. The absolute value may be 50 MPa or less. The absolute value may be 30 MPa or less. The absolute value may be 15 MPa or less. The absolute value may be 1 MPa or more.

The absolute value of the storage modulus value of the multilayer sheet 100 measured at 20° C. minus the storage modulus value of the multilayer sheet 100 measured at 80° C. may be 1,000 MPa or less. The absolute value may be 700 MPa or less. The absolute value may be 500 MPa or less. The absolute value may be 300 MPa or less. The absolute value may be 100 MPa or less. The absolute value may be 50 MPa or less. The absolute value may be 30 MPa or less. The absolute value may be 1 MPa or more.

In these cases, it is possible to effectively inhibit peeling of the multilayer sheet due to an increase in temperature.

The absolute value of the storage modulus value of the multilayer sheet 100 measured at 0° C. minus the storage modulus value of the multilayer sheet 100 measured at 20° C. may be 500 MPa or less. The absolute value may be 400 MPa or less. The absolute value may be 300 MPa or less. The absolute value may be 200 MPa or less. The absolute value may be 100 MPa or less. The absolute value may be 50 MPa or less. The absolute value may be 30 MPa or less. The absolute value may be 1 MPa or more.

The absolute value of the storage modulus value of the multilayer sheet 100 measured at −20° C. minus the storage modulus value of the multilayer sheet 100 measured at 20° C. may be 1,000 MPa or less. The absolute value may be 800 MPa or less. The absolute value may be 600 MPa or less. The absolute value may be 500 MPa or less. The absolute value may be 300 MPa or less. The absolute value may be 200 MPa or less. The absolute value may be 100 MPa or less. The absolute value may be 50 MPa or less. The absolute value may be 1 MPa or more.

The absolute value of the storage modulus value of the multilayer sheet 100 measured at −40° C. minus the storage modulus value of the multilayer sheet 100 measured at 20° C. may be 1,500 MPa or less. The absolute value may be 1,200 MPa or less. The absolute value may be 1,000 MPa or less. The absolute value may be 700 MPa or less. The absolute value may be 500 MPa or less. The absolute value may be 200 MPa or less. The absolute value may be 100 MPa or less. The absolute value may be 50 MPa or less. The absolute value may be 30 MPa or less. The absolute value may be 20 MPa or less. The absolute value may be 1 MPa or more.

In these cases, it is possible to effectively inhibit peeling of the multilayer sheet from the display due to degradation of the bending properties of the multilayer sheet caused by a decrease in temperature.

The RSM value of the multilayer sheet 100 measured at 20° C. according to Equation 1 below may be 1 to 200:

RSM=SME/SMB Equation 1

In the Equation 1, SME is the storage modulus value of the elastic layer and SMB is the storage modulus value of the adhesive layer.

In the present disclosure, it is possible to control the RSM value of the multilayer sheet 100 to be within a range predetermined by the present disclosure. In this way, the difference in mechanical properties between the layers in the multilayer sheet 100 may be adjusted, whereby it is possible to effectively inhibit not only peeling of the multilayer sheet from the surface of the attachment target but also delamination between the layers of the multilayer sheet.

A method of measuring the storage modulus of each of the elastic layer 10 and the adhesive layer 20 is the same as the method previously described, and therefore a description thereof will be omitted.

The RSM value of the multilayer sheet 100 measured at 20° C. may be 1 to 200. The RSM value may be 3 or more. The RSM value may be 5 or more. The RSM value may be 10 or more. The RSM value may be 15 or more. The RSM value may be 20 or more. The RSM value may be 180 or less. The RSM value may be 150 or less. The RSM value may be 120 or less. The RSM value may be 100 or less. The RSM value may be 80 or less.

The RSM value of the multilayer sheet 100 measured at 40° C. may be 5 to 400. The RSM value may be 10 or more. The RSM value may be 20 or more. The RSM value may be 30 or more. The RSM value may be 45 or more. The RSM value may be 55 or more. The RSM value may be 350 or less. The RSM value may be 300 or less. The RSM value may be 250 or less. The RSM value may be 220 or less. The RSM value may be 200 or less.

The RSM value of the multilayer sheet 100 measured at 0° C. may be 0.1 to 100. The RSM value may be 1 or more. The RSM value may be 3 or more. The RSM value may be 5 or more. The RSM value may be 10 or more. The RSM value may be 80 or less. The RSM value may be 65 or less. The RSM value may be 50 or less.

The RSM value of the multilayer sheet 100 measured at −20° C. may be 0.5 to 75. The RSM value may be 1 or more. The RSM value may be 3 or more. The RSM value may be 5 or more. The RSM value may be 7 or more. The RSM value may be 60 or less. The RSM value may be 50 or less. The RSM value may be 40 or less.

The RSM value of the multilayer sheet 100 measured at −40° C. may be 0.7 to 60. The RSM value may be 1 or more. The RSM value may be 3.5 or more. The RSM value may be 5.5 or more. The RSM value may be 7.5 or more. The RSM value may be 50 or less. The RSM value may be 30 or less. The RSM value may be 20 or less.

In these cases, it is possible to effectively inhibit peeling of the adhesive layer due to the modulus difference between the adhesive layer and the elastic layer or between the adhesive layer and the display.

The adhesive force of the multilayer sheet 100 may be 2 N/inch or more.

In the present disclosure, it is possible to control the adhesive force of the multilayer sheet 100. The multilayer sheet 100 may exhibit reliable adhesion even when applied to a display that is repeatedly bent or rolled.

The adhesive force of the multilayer sheet 100 is measured after curing the adhesive layer 20. The adhesive force of the multilayer sheet 100 is measured using a 180° peel test method with an advanced force gauge, with a peeling speed of 300 mm/min and a glass plate as a substrate.

For example, a model AFG50 from Mecmesin may be used as the advanced force gauge, and a model NA32G from AvanStrate may be used as the substrate.

The adhesive force of the multilayer sheet 100 may be 2 N/inch or more. The adhesive force may be 3 N/inch or more. The adhesive force may be 5 N/inch or more. The adhesive force may be 8 N/inch or more. The adhesive force may be 10 N/inch or more. The adhesive force may be 25 N/inch or less. The adhesive force may be 23 N/inch or less. The adhesive force may be 20 N/inch or less. The adhesive force may be 18 N/inch or less. In these cases, it is possible to further improve adhesion of the multilayer sheet.

The thickness of the multilayer sheet 100 may be 10 μm or more. The thickness may be 15 μm or more. The thickness may be 20 μm or more. The thickness may be 30 μm or more. The thickness may be 1,000 μm or less. The thickness may be 800 μm or less. The thickness may be 500 μm or less. The thickness may be 300 μm or less. The thickness may be 200 μm or less. The thickness may be 100 μm or less. The thickness may be 50 μm or less. In these cases, it is possible for the multilayer sheet to reliably protect a protection target, such as a display, from external impact.

FIG. 2 is a conceptual view illustrating a multilayer sheet according to another embodiment of the present disclosure. The present disclosure will be described in more detail with reference to FIG. 2.

The multilayer sheet 100 may include an adhesive layer 20 disposed on an elastic layer 10 and an adhesive layer 20 disposed under the elastic layer 10. The multilayer sheet having this structure may be utilized as an adhesive film.

The multilayer sheet 100 may include one surface and the other surface. In the multilayer sheet 100, the adhesive layer 20 may be disposed as the outermost layer on each of one surface and the other surface. The multilayer sheet having this structure is suitable for utilization as an adhesive film for a display.

FIG. 3 is a conceptual view illustrating a multilayer sheet according to yet another embodiment of the present disclosure. The present disclosure will be described in more detail with reference to FIG. 3.

The multilayer sheet 100 may include a transparent layer 30 disposed on an adhesive layer 20 and a coating layer 40 disposed on the transparent layer 30.

The transparent layer 30 may be disposed on the adhesive layer 20, while abutting the adhesive layer 20. The transparent layer 30 may be disposed on the adhesive layer 20, while not abutting the adhesive layer 20.

The coating layer 40 may be disposed on the transparent layer 30, while abutting the transparent layer 30. The coating layer 40 may be disposed on the transparent layer 30, while not abutting the transparent layer 30.

The transparent layer 30 may be used as a base layer for coating the coating layer 40.

A lower surface of the coating layer 40 may face the transparent layer 30, and an upper surface of the coating layer 40 may be the outermost surface exposed to the outside.

The coating layer 40 may be a curable coating layer.

FIG. 4 is a conceptual view illustrating a multilayer sheet according to yet another embodiment of the present disclosure. The present disclosure will be described in more detail with reference to FIG. 4.

The multilayer sheet 100 may further include a release film 50 on the adhesive layer 20.

The release film 50 may be disposed on an upper surface of the adhesive layer 20 while abutting the adhesive layer 20. The release film 50 may be disposed on the adhesive layer 20 via another layer located between a lower surface of the release film 50 and the upper surface of the adhesive layer 20.

A release base layer 52 may be used as a base layer for a release layer 51.

The release film 50 may include a release layer 51 disposed on the adhesive layer 20 and a release base layer 52 disposed on the release layer 51.

The release layer 51 may be a cured layer of a silicone resin composition including a fluorine group. Specifically, the release layer 51 may be a cured layer of release coating liquid including organopolysiloxane including a fluorine group and organopolysiloxane including an alkenyl group.

The release base layer 52 is not limited as long as the release base layer is generally used in the field of base films. For example, a polyethylene terephthalate film may be used as the release base layer 52.

### Elastic Layer

In the present disclosure, it is possible for the elastic layer 10 to have a controlled storage modulus value measured at a specific temperature. As a result, it is possible to provide excellent bending properties to the multilayer sheet 100 over a wide temperature range and to reliably protect the display.

A method of measuring the temperature-specific storage modulus value of the elastic layer 10 is the same as the method of measuring the temperature-specific storage modulus value of the multilayer sheet described above.

The storage modulus value of the elastic layer 10 measured at 20° C. may be 10 MPa or more. The storage modulus value may be 50 MPa or more. The storage modulus value may be 100 MPa or more. The storage modulus value may be 200 MPa or more. The storage modulus value may be 300 MPa or more. The storage modulus value may be 3,000 MPa or less. The storage modulus value may be 2,500 MPa or less. The storage modulus value may be 2,000 MPa or less. The storage modulus value may be 1,500 MPa or less. The storage modulus value may be 1,200 MPa or less.

The storage modulus value of the elastic layer 10 measured at 40° C. may be 10 MPa or more. The storage modulus value may be 50 MPa or more. The storage modulus value may be 100 MPa or more. The storage modulus value may be 200 MPa or more. The storage modulus value may be 1,200 MPa or less. The storage modulus value may be 1,000 MPa or less. The storage modulus value may be 800 MPa or less. The storage modulus value may be 700 MPa or less.

The storage modulus value of the elastic layer 10 measured at 60° C. may be 10 MPa or more. The storage modulus value may be 50 MPa or more. The storage modulus value may be 100 MPa or more. The storage modulus value may be 700 MPa or less. The storage modulus value may be 500 MPa or less. The storage modulus value may be 300 MPa or less.

The storage modulus value of the elastic layer 10 measured at 80° C. may be 10 MPa or more. The storage modulus value may be 20 MPa or more. The storage modulus value may be 50 MPa or more. The storage modulus value may be 70 MPa or more. The storage modulus value may be 500 MPa or less. The storage modulus value may be 350 MPa or less. The storage modulus value may be 200 MPa or less. The storage modulus value may be 170 MPa or less.

The storage modulus value of the elastic layer 10 measured at 0° C. may be 30 MPa or more. The storage modulus value may be 50 MPa or more. The storage modulus value may be 100 MPa or more. The storage modulus value may be 200 MPa or more. The storage modulus value may be 300 MPa or more. The storage modulus value may be 2,200 MPa or less. The storage modulus value may be 1,800 MPa or less. The storage modulus value may be 1,500 MPa or less. The storage modulus value may be 1,200 MPa or less. The storage modulus value may be 1,000 MPa or less. The storage modulus value may be 800 MPa or less.

The storage modulus value of the elastic layer 10 measured at −20° C. may be 50 MPa or more. The storage modulus value may be 100 MPa or more. The storage modulus value may be 150 MPa or more. The storage modulus value may be 200 MPa or more. The storage modulus value may be 300 MPa or more. The storage modulus value may be 350 MPa or more. The storage modulus value may be 400 MPa or more. The storage modulus value may be 2,400 MPa or less. The storage modulus value may be 2,000 MPa or less. The storage modulus value may be 1,500 MPa or less. The storage modulus value may be 1,200 MPa or less. The storage modulus value may be 1,000 MPa or less. The storage modulus value may be 800 MPa or less.

The storage modulus value of the elastic layer 10 measured at −40° C. may be 80 MPa or more. The storage modulus value may be 200 MPa or more. The storage modulus value may be 350 MPa or more. The storage modulus value may be 500 MPa or more. The storage modulus value may be 2,600 MPa or less. The storage modulus value may be 2,300 MPa or less. The storage modulus value may be 2,000 MPa or less. The storage modulus value may be 1,700 MPa or less. The storage modulus value may be 1,500 MPa or less. The storage modulus value may be 1,200 MPa or less. The storage modulus value may be 1,000 MPa or less. The storage modulus value may be 850 MPa or less.

In these cases, the elastic layer 10 may help to provide reliable bending properties to the multilayer sheet 100 over a wide temperature range.

The absolute value of the storage modulus value of the elastic layer 10 measured at 20° C. minus the storage modulus value of the elastic layer 10 measured at 40° C. may be 1,000 MPa or less. The absolute value may be 850 MPa or less. The absolute value may be 550 MPa or less. The absolute value may be 450 MPa or less. The absolute value may be 300 MPa or less. The absolute value may be 200 MPa or less. The absolute value may be 0.1 MPa or more.

The absolute value of the storage modulus value of the elastic layer 10 measured at 20° C. minus the storage modulus value of the elastic layer 10 measured at 60° C. may be 2,000 MPa or less. The absolute value may be 1,800 MPa or less. The absolute value may be 1,500 MPa or less. The absolute value may be 1,300 MPa or less. The absolute value may be 1,000 MPa or less. The absolute value may be 800 MPa or less. The absolute value may be 500 MPa or less. The absolute value may be 300 MPa or less. The absolute value may be 1 MPa or more.

The absolute value of the storage modulus value of the elastic layer 10 measured at 20° C. minus the storage modulus value of the elastic layer 10 measured at 80° C. may be 2,000 MPa or less. The absolute value may be 1,800 MPa or less. The absolute value may be 1,500 MPa or less. The absolute value may be 1,300 MPa or less. The absolute value may be 1,000 MPa or less. The absolute value may be 800 MPa or less. The absolute value may be 500 MPa or less. The absolute value may be 350 MPa or less. The absolute value may be 1 MPa or more.

The absolute value of the storage modulus value of the elastic layer 10 measured at 0° C. minus the storage modulus value of the elastic layer 10 measured at 20° C. may be 1,000 MPa or less. The absolute value may be 850 MPa or less. The absolute value may be 550 MPa or less. The absolute value may be 350 MPa or less. The absolute value may be 180 MPa or less. The absolute value may be 1 MPa or more.

The absolute value of the storage modulus value of the elastic layer 10 measured at −20° C. minus the storage modulus value of the elastic layer 10 measured at 20° C. may be 1,000 MPa or less. The absolute value may be 850 MPa or less. The absolute value may be 550 MPa or less. The absolute value may be 350 MPa or less. The absolute value may be 180 MPa or less. The absolute value may be 1 MPa or more.

The absolute value of the storage modulus value of the elastic layer 10 measured at −40° C. minus the storage modulus value of the elastic layer 10 measured at 20° C. may be 1,200 MPa or less. The absolute value may be 1,000 MPa or less. The absolute value may be 800 MPa or less. The absolute value may be 600 MPa or less. The absolute value may be 500 MPa or less. The absolute value may be 400 MPa or less. The absolute value may be 1 MPa or more.

In these cases, it is possible to reliably protect the display over a wide temperature range and to inhibit excessive fluctuation in bending properties of the elastic layer.

The elastic layer 10 may have an impact strength of 2,500 kJ/m2 or more. The impact strength may be 3,500 kJ/m2 or more. The impact strength may be 4,500 kJ/m2 or more. The impact strength may be 5,000 kJ/m2 or more. The impact strength may be 10,000 kJ/m2 or less. The elastic layer having these characteristics may absorb external impact well, but may not be easily broken or damaged.

The elastic layer 10 may have an absorption energy of 1.4 J or more. The absorption energy may be 1.5 J or more. The absorption energy may be 1.6 J or more. The absorption energy may be 2.0 J or less. The elastic layer having these characteristics may effectively relieve the impact transmitted to the protection target.

The impact strength and the absorption energy are measured in accordance with JIS K 7160.

The haze value of the elastic layer 10 may be 3% or less. The haze value may be 2% or less. The haze value may be 1.5% or less. The haze value may be 1.2% or less. The haze may be 0.01% or more. The haze value may be 0.1% or more.

The visible light transmittance of the elastic layer 10 may be 85% or more. The transmittance may be 88% or more. The transmittance may be 90% or more. The transmittance may be 99.99% or less.

The elastic layer having these characteristics may have optical properties suitable for application as a protective layer of the display.

The yellow index (Y.I) of the elastic layer 10 may be 1 or less.

The yellow index may be a value measured in YI E313 (D65/10) mode using a color meter Ultra Scan Pro from HunterLab.

The yellow index of the elastic layer 10 after 72 hours of exposure to ultraviolet light having a wavelength of 280 to 360 nm at a power of 3.0 W minus the yellow index of the elastic layer before exposure may be 2 or less. The yellow index of the elastic layer 10 after 72 hours of exposure to ultraviolet light having a wavelength of 280 to 360 nm at a power of 3.0 W minus the yellow index of the elastic layer before exposure may be 1 or less. The yellow index of the elastic layer 10 after 72 hours of exposure to ultraviolet light having a wavelength of 280 to 360 nm at a power of 3.0 W minus the yellow index of the elastic layer before exposure may be 0.1 or more. The elastic layer having these characteristics may have excellent ultraviolet durability by which there is slight or little yellowing of the coating layer even when exposed to ultraviolet light.

Cloudiness (cloudy phenomenon) of the elastic layer 10 may not be substantially observed. In fact, the area in which cloudiness of the elastic film is observed may be less than 1% of the total area. In this case, the total area is based on the total film area applied to a product. Cloudiness may be determined by haze measurement, and may be considered as perceivable if the haze measurement is greater than 1%. The degree of cloudiness may be adjusted by controlling the degree of gelation, molecular weight distribution, etc. of the resin used to prepare the elastic layer.

The elastic layer 10 may include polyether block amide (PEBA). Polyether block amide includes two regions: a polyamide region, which is a rigid region, and a polyether region, which is a soft region. The polyamide region may have a melting point of about 80° C. or more, specifically about 130 to 180° C., and may constitute a rigid region having a substantially crystalline phase. The polyether region may have a glass transition temperature of −40° C. or less, specifically −80 to −40° C., which is a low temperature region, and may constitute an amorphous soft region.

For example, polyether block amide may be Pebax® or Pebax® Rnew® from ARKEMA or VESTAMID® E from EVONIK.

The elastic layer 10 may include a polymer including an amide residue as a repeat unit. The elastic layer 10 may be a plastic film including a polymer having an amide residue as a repeat unit. The elastic layer 10 may be an elastomer film including a polymer having an amide residue as a repeat unit.

The content of the amide residue may be 50 wt % or more, or may be 60 wt % or more, based on the entirety of the polymer included in the elastic film. The content of amide residue may be 80 wt % or less, or may be 70 wt % or less, based on the entirety of the polymer included in the elastic film. When the polymer having these characteristics is applied to the elastic film, it is possible to provide an elastic film having better mechanical properties.

The elastic layer 10 may include elastic polyamide (long chain polyamide). For example, elastic polyamide may be Rilsan® or Rilsamid® from Arkema.

The elastic layer 10 may include thermoplastic polyurethane (TPU), i.e., a copolymer of polyurethane block (PU) and polyether block (PE), which is also referred to as polyether urethane.

The elastic layer 10 may include copolyetherester (COPE).

The thickness of the elastic layer 10 may be 500 μm or less. The thickness may be 300 μm or less. The thickness may be 200 μm or less. The thickness may be 100 μm or less. The thickness may be 80 μm or less. The thickness may be 1 μm or more. The thickness may be 5 μm or more. The thickness may be 10 μm or more. In these cases, the elastic layer may provide excellent impact resistance and bending properties to the multilayer sheet.

The elastic layer 10 may be formed by using a resin composition for the elastic layer.

The resin composition for the elastic layer may include a polymer including an amide residue as a repeat unit. The resin composition for the elastic layer may include elastic polyamide. The resin composition for the elastomeric layer may include thermoplastic polyurethane. The resin composition for the elastomeric layer may include copolyetherester (COPE).

A description of the above resins is duplicate to the foregoing and will therefore be omitted.

Any method applicable to the preparation of the film may be used as a method of shaping the resin composition for the elastic layer to have the shape of the elastic layer, and for example, a melt extrusion method may be used.

When the resin composition for the elastic layer is shaped to have the shape of the elastic sheet by melting extrusion, the temperature of melting extrusion may be 200 to 300° C. When melting extrusion is carried out within this temperature range, it is possible to provide fluidity to the resin composition without damaging the properties of the resin such that the resin composition for the elastic layer can be smoothly shaped to have the shape of the sheet.

In order to control the thickness of the elastic layer 10, the prepared elastic layer may be passed between rollers. If necessary, elastic layer protective films may be laminated on and under the elastic layer to form a laminate, and then the laminate may be passed between the rollers.

### Adhesive Layer

In the present disclosure, it is possible to reduce the difference in modulus properties between the adhesive layer 20 and the elastic layer 10 in the multilayer sheet 100 over a wide temperature range by controlling the measurement temperature-specific storage modulus value of the adhesive layer 20. As a result, it is possible to inhibit peeling of the adhesive layer 20 from the elastic layer 10 during repeated bending. At the same time, it is possible to inhibit peeling of the multilayer sheet 100 from the flexible display due to the difference in bending properties between the display and the adhesive layer 20.

A method of measuring the temperature-specific storage modulus of the adhesive layer 20 is the same as the method of measuring the temperature-specific storage modulus of the multilayer sheet described above.

The storage modulus value of the adhesive layer 20 measured at 20° C. may be 1 MPa or more. The storage modulus value may be 5 MPa or more. The storage modulus value may be 7 MPa or more. The storage modulus value may be 100 MPa or less. The storage modulus value may be 80 MPa or less. The storage modulus value may be 50 MPa or less. The storage modulus value may be 20 MPa or less.

The storage modulus value of the adhesive layer 20 measured at 40° C. may be 0.1 MPa or more. The storage modulus value may be 0.5 MPa or more. The storage modulus value may be 1 MPa or more. The storage modulus value may be 2 MPa or more. The storage modulus value may be 30 MPa or less. The storage modulus value may be 20 MPa or less. The storage modulus value may be 10 MPa or less.

The storage modulus value of the adhesive layer 20 measured at 60° C. may be 0.01 MPa or more. The storage modulus value may be 0.05 MPa or more. The storage modulus value may be 0.1 MPa or more. The storage modulus value may be 5 MPa or less.

The storage modulus value of the adhesive layer 20 measured at 80° C. may be 0.001 MPa or more. The storage modulus value may be 0.003 MPa or more. The storage modulus value may be 0.01 MPa or less.

The storage modulus value of the adhesive layer 20 measured at 0° C. may be 5 MPa or more. The storage modulus value may be 10 MPa or more. The storage modulus value may be 20 MPa or more. The storage modulus value may be 25 MPa or more. The storage modulus value may be 200 MPa or less. The storage modulus value may be 180 MPa or less. The storage modulus value may be 150 MPa or less. The storage modulus value may be 120 MPa or less. The storage modulus value may be 100 MPa or less. The storage modulus value may be 80 MPa or less. The storage modulus value may be 50 MPa or less.

The storage modulus value of the adhesive layer 20 measured at −20° C. may be 10 MPa or more. The storage modulus value may be 20 MPa or more. The storage modulus value may be 30 MPa or more. The storage modulus value may be 200 MPa or less. The storage modulus value may be 180 MPa or less. The storage modulus value may be 150 MPa or less. The storage modulus value may be 120 MPa or less. The storage modulus value may be 100 MPa or less. The storage modulus value may be 80 MPa or less.

The storage modulus value of the adhesive layer 20 measured at −40° C. may be 20 MPa or more. The storage modulus value may be 30 MPa or more. The storage modulus value may be 40 MPa or more. The storage modulus value may be 50 MPa or more. The storage modulus value may be 300 MPa or less. The storage modulus value may be 250 MPa or less. The storage modulus value may be 200 MPa or less. The storage modulus value may be 170 MPa or less. The storage modulus value may be 150 MPa or less. The storage modulus value may be 120 MPa or less. The storage modulus value may be 100 MPa or less.

The adhesive layer 20 may be a curable adhesive layer. The storage modulus value of the adhesive layer 20 measured at 20° C. after curing may be 1 MPa or more. The storage modulus value may be 5 MPa or more. The storage modulus value may be 7 MPa or more. The storage modulus value may be 100 MPa or less. The storage modulus value may be 80 MPa or less. The storage modulus value may be 50 MPa or less. The storage modulus value may be 20 MPa or less.

The storage modulus value of the adhesive layer 20 measured at 40° C. after curing may be 0.1 MPa or more. The storage modulus value may be 0.5 MPa or more. The storage modulus value may be 1 MPa or more. The storage modulus value may be 2 MPa or more. The storage modulus value may be 30 MPa or less. The storage modulus value may be 20 MPa or less. The storage modulus value may be 10 MPa or less.

The storage modulus value of the adhesive layer 20 measured at 60° C. after curing may be 0.01 MPa or more. The storage modulus value may be 0.05 MPa or more. The storage modulus value may be 0.1 MPa or more. The storage modulus value may be 5 MPa or less.

The storage modulus value of the adhesive layer 20 measured at 80° C. after curing may be 0.001 MPa or more. The storage modulus value may be 0.003 MPa or more. The storage modulus value may be 0.01 MPa or less.

The storage modulus value of the adhesive layer 20 measured at 0° C. after curing may be 5 MPa or more. The storage modulus value may be 10 MPa or more. The storage modulus value may be 20 MPa or more. The storage modulus value may be 25 MPa or more. The storage modulus value may be 200 MPa or less. The storage modulus value may be 180 MPa or less. The storage modulus value may be 150 MPa or less. The storage modulus value may be 120 MPa or less. The storage modulus value may be 100 MPa or less. The storage modulus value may be 80 MPa or less. The storage modulus value may be 50 MPa or less.

The storage modulus value of the adhesive layer 20 measured at −20° C. after curing may be 10 MPa or more. The storage modulus value may be 20 MPa or more. The storage modulus value may be 30 MPa or more. The storage modulus value may be 200 MPa or less. The storage modulus value may be 180 MPa or less. The storage modulus value may be 150 MPa or less. The storage modulus value may be 120 MPa or less. The storage modulus value may be 100 MPa or less. The storage modulus value may be 80 MPa or less.

The storage modulus value of the adhesive layer 20 measured at −40° C. after curing may be 20 MPa or more. The storage modulus value may be 30 MPa or more. The storage modulus value may be 40 MPa or more. The storage modulus value may be 50 MPa or more. The storage modulus value may be 300 MPa or less. The storage modulus value may be 250 MPa or less. The storage modulus value may be 200 MPa or less. The storage modulus value may be 170 MPa or less. The storage modulus value may be 150 MPa or less. The storage modulus value may be 120 MPa or less. The storage modulus value may be 100 MPa or less.

In these cases, the bending properties of the adhesive layer may be controlled, whereby it is possible to further improve the delamination resistance of the multilayer sheet.

The adhesive force of the adhesive layer 20 after curing may be 2 N/inch or more. The adhesive force may be 2.5 N/inch or more. The adhesive force may be 3 N/inch or more. The adhesive force may be 3.5 N/inch or more. The adhesive force may be 4 N/inch or more. The adhesive force may be 4.5 N/inch or more. The adhesive force may be 5 N/inch or more. The adhesive force may be 5.5 N/inch or more. The adhesive force may be 25 N/inch or less. The adhesive force may be 22 N/inch or less. The adhesive force may be 20 N/inch or less. The adhesive force may be 18 N/inch or less. The adhesive force may be 15 N/inch or less. The adhesive force may be 12 N/inch or less. The adhesive force may be 10 N/inch or less. In these cases, excellent adhesion may be provided to the multilayer sheet.

The adhesive force per unit thickness (1 μm) of the adhesive layer 20 after curing may be 0.8 N/inch or more. The adhesive force per unit thickness (1 μm) of the adhesive layer 20 after curing may be 0.9 N/inch or more. The adhesive force per unit thickness (1 μm) of the adhesive layer 20 after curing may be 1 N/inch or more. The adhesive force per unit thickness (1 μm) after curing of the adhesive layer 20 may be 1.2 N/inch or more. The adhesive force per unit thickness (1 μm) of the adhesive layer 20 after curing may be 1.5 N/inch or more. The adhesive force per unit thickness (1 μm) of the adhesive layer 20 after curing may be 1.8 N/inch or more. The adhesive force per unit thickness (1 μm) of the adhesive layer 20 after curing may be 2 N/inch or more. The adhesive force per unit thickness (1 μm) of the adhesive layer 20 after curing may be 2.3 N/inch or more. The adhesive force per unit thickness (1 μm) of the adhesive layer 20 after curing may be 2.5 N/inch or more. The adhesive force per unit thickness (1 μm) of the adhesive layer 20 after curing may be 3.5 N/inch or less. The adhesive force per unit thickness (1 μm) of the adhesive layer 20 after curing may be 3.2 N/inch or less. The adhesive force per unit thickness (1 μm) of the adhesive layer 20 after curing may be 3.0 N/inch or less. In these cases, an adhesive layer having a relatively small thickness may be used, which may contribute to providing excellent bending properties to the multilayer film.

A description of a method of measuring the adhesive force of the adhesive layer 20 is duplicate to the description of the method of measuring the adhesive force of the multilayer sheet and will therefore be omitted.

The total light transmittance (light transmittance) of the adhesive layer 20 according to ISO 13468 may be 85% or more. The light transmittance may be 88% or more. The light transmittance may be 89% or more. The light transmittance may be 99% or less.

The haze of the adhesive layer 20 may be 3% or less. The haze may be 2% or less. The haze may be 1.5% or less. The haze may be 1% or less. The haze may be more than 0%.

The yellow index (YI) of the adhesive layer 20 may be 3 or less. The yellow index may be 2.8 or less. The yellow index may be 2.2 or less. The yellow index may be 1.0 or less. The yellow index may be 0.8 or less. The yellow index may be 0.5 or less. The yellow index may be more than 0.

The adhesive layer has excellent optical properties and is suitable for application in the field of displays.

An acrylic-based adhesive layer, a urethane-based adhesive layer, or a silicone-based adhesive layer may be used as the adhesive layer 20, and specifically a silicone-based adhesive layer may be used. When the silicone-based adhesive layer is used, it is possible to provide an adhesive layer having high light transmittance, heat resistance, weather resistance, and the like. In particular, an adhesive layer of the present disclosure described later may have high adhesive force even at a small thickness, which may further improve the properties of the multilayer sheet compared to a conventional optically clear adhesive (OCA) such as an acrylic-based adhesive layer.

An adhesive layer having high adhesive force may be used as the adhesive layer 20.

In order for the properties of the multilayer sheet to be well maintained even after repeated bending or folding, it is necessary to improve the performance of not only the transparent layer or the coating layer 40 but also the adhesive layer that fixes the transparent layer or the coating layer and inhibits the occurrence of delamination. The inventors were able to achieve such improved performance by using the silicone-based adhesive layer.

The silicone-based adhesive layer may be obtained by applying a silicone adhesive composition and then drying and/or curing the same.

The silicone adhesive composition may include a silicone adhesive, a catalyst, and a solvent.

Any commercially available silicone adhesive utilized for optical applications may be used as the silicone adhesive. Specifically, a peroxide-curable silicone adhesive may be used, and an addition-reactive silicone adhesive may be used.

For example, KR-100, KR-101-10, or KR-130 from Shin-Etsu Chemical, DOWSIL SH 4280 from Dow, or SilGrip PSA 510 from Momentive Performance Materials may be used as the peroxide-cure silicone adhesive.

For example, KR-3700, KR-3701, X-40-3237, X-40-3240, or X-40-3291-1 from Shin-Etsu Chemical, DOWSIL SD4580, DOWSIL 4584, DOWSIL 4585, or DOWSIL 4587L from Dow, or SilGrip TSR1512 or TSR1516 from Momentive Performance Materials may be used as the addition-reactive silicone adhesive.

The use of the addition-reactive silicone adhesive as the silicone adhesive may be advantageous in terms of process convenience.

In the present disclosure, a silicone MQ resin may be further included in order to increase the adhesive force of the silicone-based adhesive layer. Here, the silicone MQ resin is a polymer having at least two methyl groups on a siloxane skeleton among cage-like oligosiloxanes represented by the general formula RnSiXmOy. In the general formula, R may be an alkyl group having a carbon number of 1 to 5, including at least 2 methyl groups thereamong. In the general formula, X is hydrogen, a hydroxyl group, a chloride group, or an alkoxy group having a carbon number of 1 to 5. In the general formula, n, m, and y are each an integer of 2 to 200. Specifically, mono-terminated siloxane units (M units) represented by R1R2X3SiO1/2 and tetra-terminated siloxane units (Q units) represented by SiO4/2 may be included. The weight average molecular weight may be 2,000 to 8,000 g/mol. The application of the silicone MQ resin to the adhesive layer may further improve adhesion, particularly initial adhesion.

The silicone adhesive composition may include at least 5 parts by weight, at least 8 parts by weight, at least 10 parts by weight, or at least 20 parts by weight of the silicone MQ resin based on 100 parts by weight of the silicone adhesive. The silicone adhesive composition may include no more than 70 parts by weight, no more than 60 parts by weight, or no more than 50 parts by weight of the silicone MQ resin based on 100 parts by weight of the silicone adhesive. When the silicone adhesive and the silicone MQ resin are used in such a ratio, the adhesive layer may have excellent adhesion even with a fairly small thickness.

For example, X-92-128 or X-41-3003 from Shin-Etsu Chemical or SilGrip SR545 or SilGrip SR1000 from Momentive Performance Materials may be used as the silicone MQ resin.

A platinum catalyst may be used as the catalyst. For example, CATPL-50T from Shin-Etsu Chemical may be used. The catalyst may shorten the curing time, whereby, even when a transparent film or substrate having relatively heat-sensitive characteristics is used, the adhesive layer may be efficiently formed without substantially damaging the substrate.

The silicone adhesive composition may include 0.5 to 2 parts by weight, or 0.8 to 1.5 parts by weight of the catalyst based on 100 parts by weight of the silicone adhesive. In this case, the catalyst may effectively promote curing reaction in the composition.

The silicone adhesive composition may further include a solvent. The solvent may dilute the silicone adhesive composition and provide fluidity to the composition to allow for favorable workability of the coating or the like. In addition, the solvent helps to form an adhesive layer that is relatively thin and has excellent overall physical properties. For example, toluene may be used as the solvent, but any other solvent may be used without limitation as long as the properties of the silicone adhesive composition are not impaired.

For example, the silicone adhesive composition may include 20 to 45 wt % of the silicone adhesive, 2 to 25 wt % of the silicone MQ resin, 0.2 to 0.5 wt % of the catalyst, and 50 to 70 wt % of the solvent.

The silicone adhesive composition may be coated on the elastic layer 10 to form a silicone-based curable adhesive layer 20. The silicone adhesive composition may be coated on one surface of a separate base film (not shown) and then laminated onto the elastic layer 10 to form the silicone-based curable adhesive layer. However, depending on the process sequence, drying and curing may be performed immediately after coating or may be performed as separate processes. The silicone adhesive composition may form a thin layer by coating, and this layer may be included in the adhesive layer before being dried and fully cured by heat or light. The dried layer of the silicone adhesive composition before curing is referred to as a precursor layer of the silicone curable adhesive layer.

The precursor layer may be cured by heat or light to form the adhesive layer 20. For example, the precursor layer and a surface to be adhered may be disposed in direct contact with each other, and the adhesive layer 20 may be formed by heat curing at 90 to 130° C. for 1 to 5 minutes.

The adhesive layer 20 may include a silicone adhesive-derived repeat unit and a silicone MQ resin-derived repeat unit. The adhesive layer 20 may include at least 5 parts by weight, at least 8 parts by weight, at least 10 parts by weight, at least 20 parts by weight, at least 30 parts by weight, or at least 40 parts by weight of the silicone MQ resin-derived repeat unit based on 100 parts by weight of the silicone adhesive-derived repeat unit. The adhesive layer 20 may include no more than 90 parts by weight, no more than 80 parts by weight, no more than 70 parts by weight, or no more than 60 parts by weight of the silicone MQ resin-derived repeat unit based on 100 parts by weight of the silicone adhesive-derived repeat unit. In these cases, the adhesive layer may achieve excellent optical properties and adhesion while having a small thickness.

The adhesive layer 20 may include at least 0.1 parts by weight, at least 0.2 parts by weight, at least 0.3 parts by weight, or at least 0.5 parts by weight of the catalyst based on 100 parts by weight of the silicone adhesive-derived repeat unit and the silicone MQ resin-derived repeat unit. The adhesive layer 20 may include no more than 5 parts by weight, no more than 4 parts by weight, no more than 3 parts by weight, no more than 2 parts by weight of the catalyst based on 100 parts by weight of the silicone adhesive-derived repeat unit and the silicone MQ resin-derived repeat unit. In these cases, it is possible to effectively improve efficiency of the curing process for the precursor layer.

The thickness of the adhesive layer 20 may be more than 1 μm. The thickness may be 1.5 μm or more. The thickness may be 1.8 μm or more. The thickness may be 2 μm or more. The thickness may be 2.5 μm or more. The thickness may be 3 μm or more. The thickness may be 3.5 μm or more. The thickness may be 20 μm or less. The thickness may be 10 μm or less. The thickness may be 8 μm or less. The thickness may be 7 μm or less. In these cases, it is possible to obtain an excellent adhesion effect.

### Other Layers

### Transparent Layer

The transparent layer 30 may be used as a base layer for the coating layer 40.

The total light transmittance (light transmittance) of the transparent layer 30 according to ISO 13468 may be 85% or more. The light transmittance may be 88% or more, 89% or more, or 99% or less. However, the light transmittance is not limited thereto as long as the transparent layer can be used as a support layer for a display cover film.

The haze of the transparent layer 30 may be 3% or less. The haze may be 2% or less, 1.5% or less, or 1% or less. The haze may be more than 0%. In these cases, the multilayer sheet may be more transparent.

The yellow index (YI) of the transparent layer 30 may be 3 or less. For example, the transmission yellow index may be 3 or less, 2.8 or less, 2.2 or less, 1.0 or less, 0.8 or less, or 0.5 or less. In addition, the transmission yellow index may be more than 0.

The transparent layer 30 may have excellent retardation properties. The in-plane directional retardation of the transparent layer 30 may be 600 nm or less, 500 nm or less, 400 nm or less, 300 nm or less, or 200 nm or less. The in-plane directional retardation of the transparent layer 30 may be 0 nm or more, 10 nm or more, 30 nm or more, or 50 nm or more. In these cases, when the multilayer sheet is applied to a front surface of the display, the possibility of rainbow stains depending on the viewing angle may be effectively reduced, and the transparent layer may have reliable mechanical properties.

The minimum in-plane directional retardation of the transparent layer 30 may be 200 nm or less or 150 nm or less. Specifically, the minimum in-plane directional retardation may be 120 nm or less, 100 nm or less, 85 nm or less, 75 nm or less, or 65 nm or less.

The thickness directional retardation of the transparent layer 30 may be 4,000 or more, 5,000 nm or more, or 5,500 nm or more. The maximum thickness directional retardation (Rthmax) of the transparent layer 30 may be 6,000 nm or more, 6,500 nm or more, 7,500 nm or more, 8,000 nm or more, or 8,500 nm or more.

The ratio of the thickness directional retardation to the in-plane directional retardation of the transparent layer 30 may be 10 or more, 15 or more, or 20 or more. Smaller in-plane directional retardation and larger thickness directional retardation advantageous to preventing rainbow stains, and therefore it is preferable for the ratio to be large.

The ratio of the maximum thickness directional retardation to the minimum in-plane directional retardation of the transparent layer 30 may be 30 or more, 40 or more, 50 or more, or 60 or more.

The transparent layer having the above-described properties may have a large degree of molecular orientation and facilitated crystallization, and thus may have more than adequate mechanical properties. In addition, the transparent layer may effectively inhibit the occurrence of rainbow stains.

The retardation is based on the value measured in a transparent layer having a thickness of 40 μm to 50 μm.

The tensile strength of the transparent layer 30 may be 15 kgf/mm2 or more. The tensile strength may be 18 kgf/mm2 or more, 20 kgf/mm2 or more, 21 kgf/mm2 or more, or 22 kgf/mm2 or more.

The elongation of the transparent layer 30 may be 15% or more. The elongation may be 16% or more, 17% or more, or 17.5% or more.

The modulus of the transparent layer 30 may be 2.5 GPa or more. The modulus may be 3 GPa or more, 3.5 GPa or more, 3.8 GPa or more, or 4.0 GPa or more. The modulus may be 10 GPa or less or 8 GPa or less.

The compressive strength of the transparent layer 30 may be 0.4 kgf/μm or more. The compressive strength may be 0.45 kgf/μm or more or 0.46 kgf/μm or more.

A polyester-based film, a polyimide-based film, a polyamide-based film, or a polyimide-amide-based film may be used as the transparent layer 30.

The transparent layer 30 may be a polyester-based film. The polyester-based film may include a polyester-based resin.

The polyester-based resin may be a homopolymer resin or a copolymer resin in which dicarboxylic acid and diol are polycondensed. The polyester-based resin may be a blended resin in which the homopolymeric resin or copolymeric resin is mixed.

Examples of dicarboxylic acid include terephthalic acid, isophthalic acid, orthophthalic acid, 2,5-naphthalenedicarboxylic acid, 2,6-naphthalenedicarboxylic acid, 1,4-naphthalenedicarboxylic acid, 1,5-naphthalenedicarboxylic acid, diphenylcarboxylic acid, diphenoxyethanedicarboxylic acid, diphenylsulfonecarboxylic acid, anthracenedicarboxylic acid, 1,3-cyclopentanedicarboxylic acid, 1,3-cyclohexanedicarboxylic acid, 1,4-cyclohexanedicarboxylic acid, hexahydroterephthalic acid, hexahydroisophthalic acid, malonic acid, dimethylmalonic acid, succinic acid, 3,3-diethylsuccinic acid, glutaric acid, 2,2-dimethylglutaric acid, adipic acid, 2-methyladipic acid trimethyladipic acid, pimelic acid, azelaic acid, sebacic acid, suberic acid, and dodecanedicarboxylic acid.

Examples of diol include ethylene glycol, propylene glycol, hexamethylene glycol, neopentyl glycol, 1,2-cyclohexanedimethanol, 1,4-cyclohexanedimethanol, decamethylene glycol, 1,3-propanediol, 1,4-butanediol, 1,5-pentanediol, 1,6-hexanediol, 2,2-bis(4-hydroxyphenyl)propane, and bis(4-hydroxyphenyl)sulfone.

Preferably, the polyester-based resin is a highly crystalline aromatic polyester-based resin, for example, a polyethylene terephthalate (PET) resin may be the principal component.

When the transparent layer 30 is a polyester-based film, the transparent layer 30 may include at least 85 wt %, at least 90 wt %, at least 95 wt %, or at least 99 wt % of the polyester-based resin.

The polyester-based film may further include a polyester-based resin other than the PET resin. Specifically, the polyester-based film may further include about 15 wt % or less of a polyethylene naphthalate (PEN) resin. More specifically, the polyester-based film may further include about 0.1 wt % to 10 wt % or about 0.1 wt % to 5 wt % of the PEN resin.

The polyester-based film having this composition may have increased crystallinity and improved mechanical properties, such as tensile strength, during preparation processes such as heating and stretching.

The transparent layer 30 may further include a filler in addition to the polyester-based resin.

The filler may be at least one selected from the group consisting of barium sulfate, silica, and calcium carbonate. As the filler is included, the transparent layer 30 may have controlled roughness characteristics and improved windability. In addition, the drivability and the scratch improvement effect may be improved at the time of film preparation.

The particle diameter of the filler may be 0.01 μm or more and less than 1.0 μm. The particle diameter of the filler may be, but is not limited to, 0.05 μm to 0.9 μm or 0.1 μm to 0.8 μm.

The filler may be included so as to account for 0.01 to 3 wt % based on the total weight of the transparent layer 30. The filler may be included so as to account for 0.05 to 2.5 wt %, 0.1 to 2 wt %, or 0.2 to 1.7 wt % based on the total weight of the transparent layer 30; however, the embodiment is not limited thereto.

The thickness of the transparent layer 30 may be 15 μm or more, 20 μm or more, 30 μm or more, 40 μm or more, 55 μm or more, 65 μm or more, or 75 μm or more, and may also be 500 μm or less, 400 μm or less, 300 μm or less, 200 μm or less, 120 μm or less, 95 μm or less, or 85 μm or less. As a specific example, the thickness of the transparent layer 30 may be 15 μm to 120 μm, more specifically 20 μm to 95 μm or from 25 μm to 85 μm. The transparent layer having these thicknesses may have excellent optical properties along with sufficient mechanical properties.

SH33/34, SH37/38, TF110, V7610, V5400, V7611, TU94, TU63A, and TOF50, which are commercially available products from SKC, may be used as the transparent layer 30; however, the embodiment is not limited thereto.

A method of preparing the transparent layer is based on an ordinary film preparation method. For example, the polyester-based film may be prepared by a preparation method including the steps of (1) extruding a composition including a polyester-based resin to prepare an unstretched film, (2) stretching the unstretched film in a longitudinal direction and a width direction, and (3) thermally fixing the stretched film.

In the preparation method, the unstretched film is prepared by extruding, preheating, stretching, and thermally fixing. Extrusion may be performed at a temperature of 230° C. to 300° C. or 250° C. to 280° C.

The unstretched film is preheated at a predetermined temperature before stretching. The preheating temperature range may be determined as a range satisfying a range of Tg+5° C. to Tg+50° C. based on the glass transition temperature (Tg) of the polyester-based resin and at the same time satisfying a range of 70° C. to 90° C. Within the above range, the unstretched film may have flexibility allowing easy stretching thereof, and at the same time, a breaking phenomenon during stretching may be effectively prevented.

Biaxial stretching may be performed as stretching, and, for example, biaxial stretching may be performed in a width direction (tenter direction, TD) and a longitudinal direction (machine direction, MD) using a simultaneous biaxial stretching method or a sequential biaxial stretching method. Preferably, the sequential biaxial stretching method, in which stretching is performed first in one direction and then stretching is performed in a direction perpendicular to the direction, is performed.

The longitudinal direction stretching ratio may be 2.0 times to 5.0 times, more specifically 2.8 times to 3.5 times. In addition, the width direction stretching ratio may be 2.0 times to 5.0 times, more specifically 2.9 times to 3.7 times. Preferably, the longitudinal direction stretching ratio d1 and the width direction stretching ratio d2 are similar to each other, and specifically, the ratio (d2/d1) of the longitudinal direction stretching ratio d2 to the width direction stretching ratio d1 may be 0.5 to 1.0, 0.7 to 1.0, or 0.9 to 1.0. Each of the stretching ratios d1 and d2 is the ratio of the length after stretching to the length before stretching on the assumption that the length before stretching is 1.0. In addition, the stretching speed may be 6.5 m/min to 8.5 m/min, but is not particularly restricted.

The stretched sheet may be thermally fixed at 150° C. to 250° C., more specifically at 160° C. to 230° C. Thermal fixing may be performed for 5 seconds to 1 minute, more specifically for 10 seconds to 45 seconds.

After thermal fixing is started, the film may be relaxed in the longitudinal direction and/or in the width direction, and at this time the temperature may be 150° C. to 250° C.

### Coating Layer

The coating layer 40 may include at least one coating material of an organic component, an inorganic component, and a composite of an organic and inorganic components.

The coating material may include an organic resin. Specifically, the organic resin may be a curable resin, or may be a binder resin.

The coating layer 40 may be a curable coating layer.

The coating layer 40 may include at least one of a urethane acrylate-based compound, an acrylic ester-based compound, an acrylate-based compound, and an epoxy acrylate-based compound or a cured product of the compound.

The urethane acrylate-based compound may include a urethane bond as a repeat unit and may have a plurality of functional groups.

The urethane acrylate-based compound may be a urethane compound formed by reaction between a diisocyanate compound and polyol, and a terminal end of the urethane compound is substituted with an acrylate group.

The diisocyanate compound may include at least one of a straight-chain, branched, or cyclic aliphatic diisocyanate compound having a carbon number of 4 to 12 and an aromatic diisocyanate compound having a carbon number of 6 to 20.

Polyol includes 2 to 4 hydroxyl groups (—OH), and may be a straight-chain, branched, or cyclic aliphatic polyol compound having a carbon number of 4 to 12 or an aromatic polyol compound having a carbon number of 6 to 20. The terminal end substitution by the acrylate group may be performed by an acrylate-based compound having a functional group capable of reacting with an isocyanate group (—NCO). For example, an acrylate-based compound having a hydroxy group, an amine group, etc. may be used, and hydroxyalkyl acrylate or aminoalkyl acrylate having a carbon number of 2 to 10 may be used.

The urethane acrylate-based compound may include 2 to 15 functional groups.

Examples of the urethane acrylate-based compound include, but are not limited to, a 2-functional urethane acrylate oligomer having a weight average molecular weight of 1,400 to 25,000, a 3-functional urethane acrylate oligomer having a weight average molecular weight of 1,700 to 16,000, a 4-functional urethane acrylate oligomer having a weight average molecular weight of 500 to 2,000, a 6-functional urethane acrylate oligomer having a weight average molecular weight of 818 to 2,600, a 9-functional urethane acrylate oligomer having a weight average molecular weight of 2,500 to 5,500, a 10-functional urethane acrylate oligomer having a weight average molecular weight of 3,200 to 3,900, and a 15-functional urethane acrylate oligomer having a weight average molecular weight of 2,300 to 20,000.

The glass transition temperature (Tg) of the urethane acrylate-based compound may be −80° C. to 100° C., −80° C. to 90° C., −80° C. to 80° C., −80° C. to 70° C., −80° C. to 60° C., −70° C. to 100° C., −70° C. to 90° C., −70° C. to 80° C., −70° C. to 70° C., −70° C. to 60° C., −60° C. to 100° C., −60° C. to 90° C., −60° C. to 80° C., −60° C. to 70° C., −60° C. to 60° C., −50° C. to 100° C., −50° C. to 90° C., −50° C. to 80° C., −50° C. to 70° C., or −50° C. to 60° C.

The acrylic ester-based compound may be at least one selected from the group consisting of substituted or unsubstituted acrylate and substituted or unsubstituted methacrylate. The acrylic ester-based compound may include 1 to 10 functional groups.

Examples of the acrylic ester-based compound include, but are not limited to, trimethylolpropane triacrylate (TMPTA), trimethylolpropanethoxy triacrylate (TMPEOTA), glycerin propoxylated triacrylate (GPTA), pentaerythritol tetraacrylate (PETA), and dipentaerythritol hexaacrylate (DPHA).

The weight average molecular weight of the acrylic ester-based compound may be 500 to 6,000, 500 to 5,000, 500 to 4,000, 1000 to 6,000, 1,000 to 5,000, 1,000 to 4,000, 1,500 to 6,000, 1,500 to 5,000, or 1,500 to 4,000.

The acrylate equivalent of the acrylic ester-based compound may be 50 g/eq to 300 g/eq, 50 g/eq to 200 g/eq, or 50 g/eq to 150 g/eq.

The acrylate-based compound may include 1 to 10 functional groups. Examples of the acrylate-based compound include a 1-functional acrylate oligomer having a weight average molecular weight of 100 to 300, a 2-functional acrylate oligomer having a weight average molecular weight of 250 to 2000, and an epoxy acrylate oligomer having a weight average molecular weight of 1,000 to 3,000.

The epoxy acrylate-based compound may include 1 to 10 functional groups. Examples of the epoxy acrylate-based compound include, but are not limited to, a 1-functional epoxy acrylate oligomer having a weight average molecular weight of 100 to 300, a 2-functional epoxy acrylate oligomer having a weight average molecular weight of 250 to 2,000, and a 4-functional epoxy acrylate oligomer having a weight average molecular weight of 1,000 to 3,000. The epoxy equivalent of the epoxy acrylate-based compound may be 50 g/eq to 300 g/eq, 50 g/eq to 200 g/eq, or 50 g/eq to 150 g/eq.

The content of the organic resin may be 30 wt % to 100 wt %, 40 wt % to 90 wt %, or 50 wt % to 80 wt % based on the total weight of the coating layer 40.

The coating layer 40 may not include an inorganic filler, such as silica. In this case, adhesion between the transparent film layer and the coating layer 40 having the composition described above may be improved.

The coating layer 40 may optionally further include a filler.

The filler may be, for example, inorganic particles. Examples of the filler may include silica, barium sulfate, zinc oxide, and alumina.

The particle diameter of the filler may be 1 nm to 100 nm. The particle diameter of the filler may be 5 nm to 50 nm or 10 nm to 30 nm.

The filler may include inorganic fillers having different particle diameters. The filler may include a first inorganic filler having D50 of 20 nm to 35 nm and a second inorganic filler having D50 of 40 nm to 130 nm.

The content of the filler may be 25 wt % or more, 30 wt % or more, or 35 wt % or more based on the total weight of the coating layer 40. In addition, the content of the filler may be 50 wt % or less, 45 wt % or less, or 40 wt % or less based on the total weight of the coating layer 40.

In these cases, the mechanical properties of the filler may be improved.

The coating layer 40 may further include a photoinitiator or a reactant thereof. The photoinitiator or the like may initiate a curing reaction of the coating layer 40.

Examples of the photoinitiator may include, but are not limited to, 1-hydroxy-cyclohexyl-phenyl ketone, 2-hydroxy-2-methyl-1-phenyl-1-propanone, 2-hydroxy-1-[4-(2-hydroxyethoxy)phenyl]-2-methyl-1-propanone, methylbenzoyl formate, α,α-dimethoxy-a-phenylacetophenone, 2-benzoyl-2-(dimethylamino)-1-[4-(4-morpholinyl)phenyl]-1-butanone, 2-methyl-1-[4-(methylthio)phenyl]-2-(4-morpholinyl)-1-propanone diphenyl(2,4,6-trimethylbenzoyl)-phosphine oxide, or bis(2,4,6-trimethylbenzoyl)-phenyl phosphine oxide. In addition, there are Irgacure 184, Irgacure 500, Irgacure 651, Irgacure 369, Irgacure 907, Darocur 1173, Darocur MBF, Irgacure 819, Darocur TPO, Irgacure 907, and Esacure KIP 100F as commercially available products. The photoinitiator may be used alone or in a mixture of two or more.

The coating layer 40 may further include an antifouling agent. The coating layer 40 may include a fluorinated compound as an antifouling agent. The fluorinated compound may perform an antifouling function. Specifically, the fluorinated compound may be an acrylate-based compound having a perfluorinated alkyl group, and a specific example thereof may be, but is not limited to, perfluorohexylethyl acrylate.

The coating layer 40 may further include an antistatic agent. The antistatic agent may include an ionic surfactant. For example, the ionic surfactant may include an ammonium salt or a quaternary alkylammonium salt, wherein each of the ammonium salt and the quaternary alkylammonium salt may include a halide such as a chloride or a bromide.

The coating layer 40 may further include an additive, such as a surfactant, a UV absorber, a UV stabilizer, an anti-yellowing agent, a leveling agent, or a dye configured to improve the color value. For example, the surfactant may be a 1- to 2-functional fluorinated acrylate, fluorinated surfactant, or silicone-based surfactant.

The surfactant may be included in the coating layer 40 in a dispersed or cross-linked form. In addition, the UV absorber may be a benzophenone-based compound, a benzotriazole-based compound, or a triazine-based compound, and the UV stabilizer may be tetramethyl piperidine. The content of the additive may be variously adjusted within a range that does not degrade the properties of the coating layer 40. For example, the content of the additive may be, but is not limited to, 0.01 to 10 wt % based on the total of the coating layer 40.

The coating layer 40 may be configured as a single layer or two or more layers.

The coating layer 40 may be formed as a single layer, which may simultaneously perform an anti-fingerprint or antifouling function while increasing the surface durability of the multilayer sheet.

The thickness of the coating layer 40 may be 2 μm or more, 3 μm or more, 5 μm or more, or 7 μm or more, and may also be 50 μm or less, 30 μm or less, 20 μm or less, or 10 μm or less. Such a thickness allows the multilayer sheet to have a small thickness and provides the multilayer sheet with durability, such as surface hardness, at an appropriate level or higher while maintaining the overall flexibility of the multilayer sheet.

The coating layer 40 may be formed using a method of preparing the coating layer.

The method of preparing the coating layer may include the step of coating and curing a composition for preparing the coating layer.

The composition for preparing the coating layer may include at least one of an organic resin composition, an inorganic resin composition, and an organic and inorganic composite composition.

The composition for preparing the coating layer may include at least one of an acrylate-based compound, a siloxane compound, and a silsesquioxane compound.

In addition, the composition may further include inorganic particles.

As a specific example, the composition for preparing the coating layer may include a urethane acrylate-based compound, an acrylic ester-based compound, or a fluorinated compound.

In addition, the composition for preparing the coating layer may further include a photoinitiator, an antifouling additive, an antistatic agent, other additives, and/or an organic solvent, as needed.

An alcohol-based solvent, such as methanol, ethanol, isopropyl alcohol, or butanol, an alkoxy alcohol-based solvent, such as 2-methoxyethanol, 2-ethoxyethanol, or 1-methoxy-2-propanol, a ketone-based solvent, such as acetone, methylethyl ketone, methylisobutyl ketone, methyl propyl ketone, or cyclohexanone, an ether-based solvent, such as propylene glycol monopropyl ether, propylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, diethylene glycol-2-ethylhexylether, or an aromatic solvent, such as benzene, toluene, or xylene, may be used alone or in combination as the organic solvent.

The content of the organic solvent may be variously adjusted within a range that does not degrade the physical properties of the coating layer and thus is not particularly restricted. However, the organic solvent may be included such that the weight ratio of solids to the organic solvent is about 1:1 to 250 based on the solids among the ingredients included in the composition for preparing the coating layer. Within the range, the organic solvent may have appropriate fluidity and applicability.

The composition for preparing the coating layer may include 10 to 30 wt % of the organic resin, 0.1 to 5 wt % of the photoinitiator, 0.01 to 2 wt % of the antifouling additive, 0.1 to 10 wt % of the antistatic agent, and a residual amount of the organic solvent.

According to the composition, the mechanical properties, the antifouling properties, and the antistatic properties of the coating layer may be improved together.

The composition for preparing the coating layer may be coated to the transparent film using an ordinary coating method and then cured. The coating method may be a bar coating method, a knife coating method, a roll coating method, a blade coating method, a die coating method, a micro-gravure coating method, a coma coating method, a slot die coating method, a lip coating method, or a solution casting method.

The coated composition for preparing the coating layer may be subjected to drying and curing processes in sequence or simultaneously.

Drying is a process of removing the organic solvent from the coated composition for preparing the coating layer. Drying may be performed at a temperature of 40° C. to 100° C., preferably 40° C. to 80° C., 50° C. to 100° C., or 50° C. to 80° C., and may be performed for about 1 minute to 20 minutes, preferably 1 minute to 10 minutes or 1 minute to 5 minutes.

Curing is a process of inducing a chemical reaction in the composition for preparing the coating layer to form a film. An appropriate light curing and/or thermal curing method may be used depending on the resin or the like applied in the composition for preparing the coating layer.

### Substrate Layer

The multilayer sheet 100 may further include a substrate layer (not shown) disposed on the adhesive layer 20.

The substrate layer may be disposed directly on the adhesive layer 20. If another layer is disposed between the substrate layer and the adhesive layer 20, the substrate layer may not be disposed directly on the adhesive layer 20.

The material for the substrate layer is not restricted as long as the material is a resin that can be ordinarily utilized in the field of substrate films. For example, the substrate layer may include at least one of a polyester resin, a polyimide resin, and a polyether block amide resin. In particular, any one of a polyester film, a polyimide film, and a polyether block amide film may be used as the substrate layer.

The polyester film may be a polyethylene terephthalate (PET) film.

The multilayer sheet 100 may include two or more substrate layers. In this case, the multilayer sheet 100 may have a structure in which the substrate layers and the adhesive layer 20 are alternately laminated.

### Method of Preparing Multilayer Sheet

A method of preparing a multilayer sheet according to another embodiment of the present disclosure may include the steps of preparing an elastic layer and laminating an adhesive layer on the elastic layer.

The step of laminating the adhesive layer on the elastic layer may include a process of coating and drying a silicone adhesive composition on the elastic layer to form a precursor layer. The step of laminating the adhesive layer on the elastic layer may further include a process of curing the precursor layer to form the adhesive layer.

If the multilayer sheet includes two or more adhesive layers and has a structure in which the elastic layer and the adhesive layers are alternately laminated, the method of preparing the multilayer sheet may further include the step of laminating a pre-prepared elastic layer on the adhesive layer.

The method of preparing the multilayer sheet may further include the step of disposing a transparent layer on the adhesive layer as needed, and may further include the step of forming a coating layer on the transparent layer.

The method of preparing the multilayer sheet may further include the step of disposing a release film on the adhesive layer as needed.

A description of a method of forming each of the layers is duplicate to the foregoing and will therefore be omitted.

### Multilayer Electronic Device

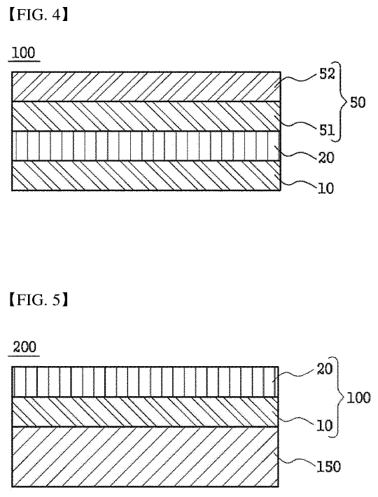

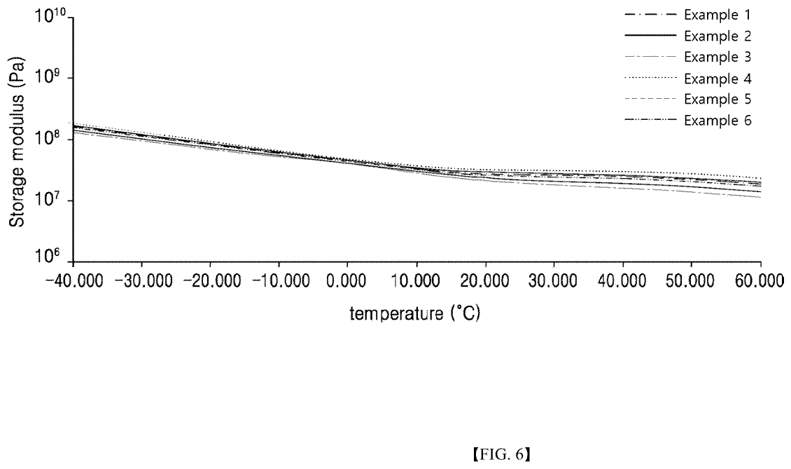

FIG. 5 is a conceptual view illustrating a multilayer electronic device according to a further embodiment of the present disclosure. The embodiment will be described with reference to FIG. 5.

The multilayer electronic device 200 according to the further embodiment of the present disclosure includes a multilayer sheet 100 and a light emitting functional layer 150 disposed under the multilayer sheet 100.

The multilayer sheet 100 may be used as a cover layer of the multilayer electronic device 200.

A description of the multilayer sheet 100 is duplicate to the foregoing and will therefore be omitted.

The multilayer electronic device 200 may be, for example, a display device, and may be, for example, a large-area display device, a foldable display device, a bendable display device, or a flexible display device. In addition, the multilayer electronic device may be a bendable mobile communication device (e.g., a mobile phone) or a bendable laptop computer.

The light emitting functional layer 150 includes a light emitting layer (not shown).

The light emitting layer includes an element configured to emit light in response to a signal from the display device. For example, the light emitting layer may include a signal transmitting layer configured to transmit an external electrical signal to a chromogenic layer, the chromogenic layer disposed on the signal transmitting layer and being configured to develop color in response to a given signal, and an encapsulation layer configured to protect the chromogenic layer. The signal transmitting layer may include a thin film transistor (TFT), and for example, LTPS, a-SiTFT, or oxide TFT may be used; however, the embodiment is not limited thereto.

Thin film encapsulation (TFE) may be used as the encapsulation layer; however, the embodiment is not limited thereto.

The light emitting layer may be disposed on a support layer (not shown).

The support layer may be a layer having insulating properties and heat resistance properties, and for example, a polyimide film, a glass layer, or a PET film may be used.

The light emitting functional layer 150 may further include a sensor layer (not shown). A touch sensor may be used as the sensor layer.

The light emitting functional layer 150 may further include a polarizing layer (not shown). The polarizing layer may be disposed on the light emitting layer, or may be disposed on the sensor layer.

Hereinafter, specific examples will be described in more detail.

### Manufacturing Example: Preparation of Multilayer Sheet

Examples: In each example, an elastic layer was prepared using a PEBA resin product from Arkema. Specifically, the PEBA resin was placed in an extruder, was melt-mixed at about 220° C., and was extruded as a single layer to prepare an elastic layer. The product name of the PEBA resin used to prepare the elastic layer for each example and the thickness of the elastic layer are listed in Table 1 below.

An adhesive layer was formed on each of one surface and the other surface of the prepared elastic layer. Specifically, a silicone-based adhesive composition was coated to one surface and the other surface of the elastic layer, and was then dried and cured to form an adhesive layer. Drying and curing was performed at a temperature of 90° C. for 5 minutes.

A composition including 29.851 wt % of Shin-Etsu KR-3700 model as a silicone adhesive, 7.164 wt % of Shin-Etsu X-92-128 model as a silicone MQ resin, 0.299 wt % of Shin-Etsu CAT-PL-50T model as a platinum catalyst, and 62.686 wt % of toluene was used as the silicone-based adhesive composition.

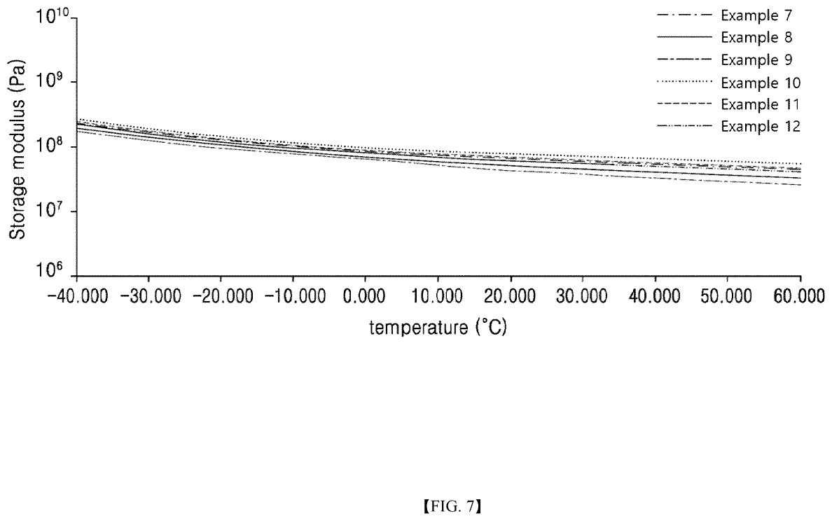

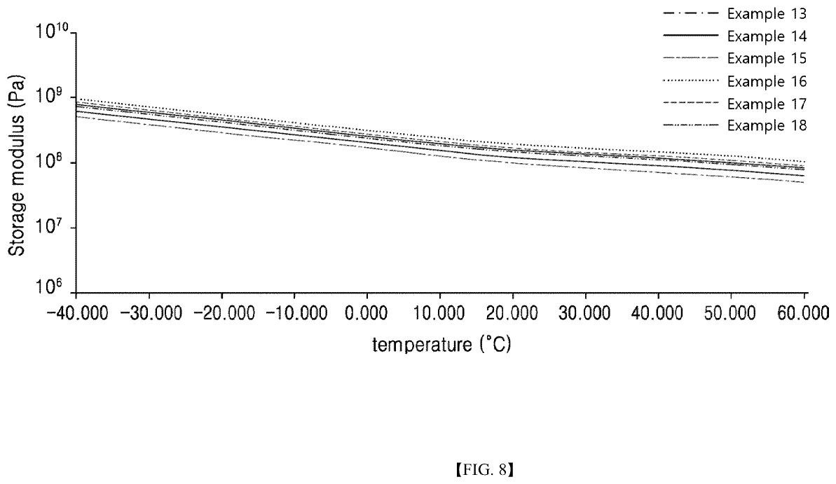

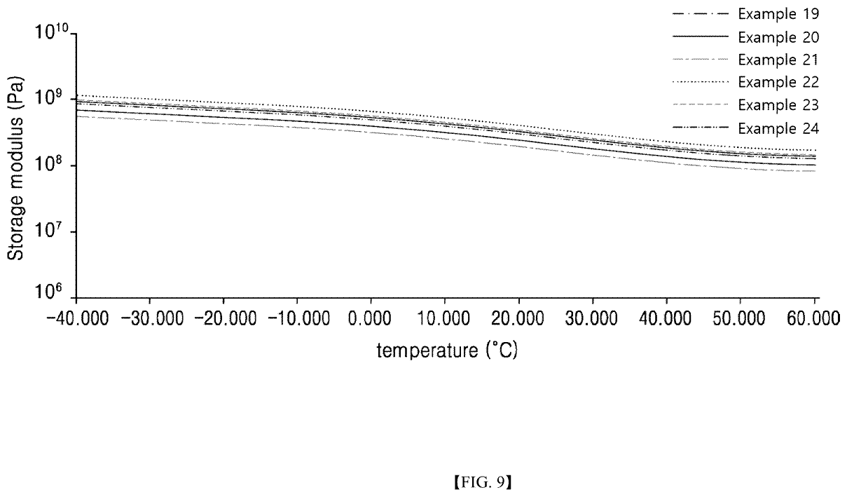

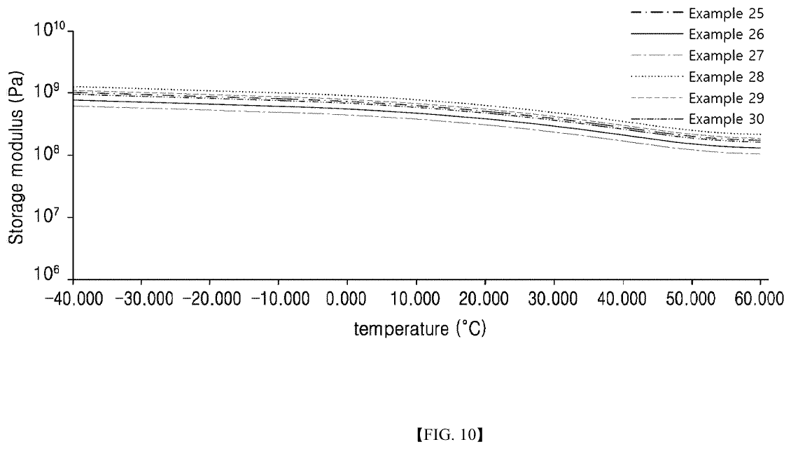

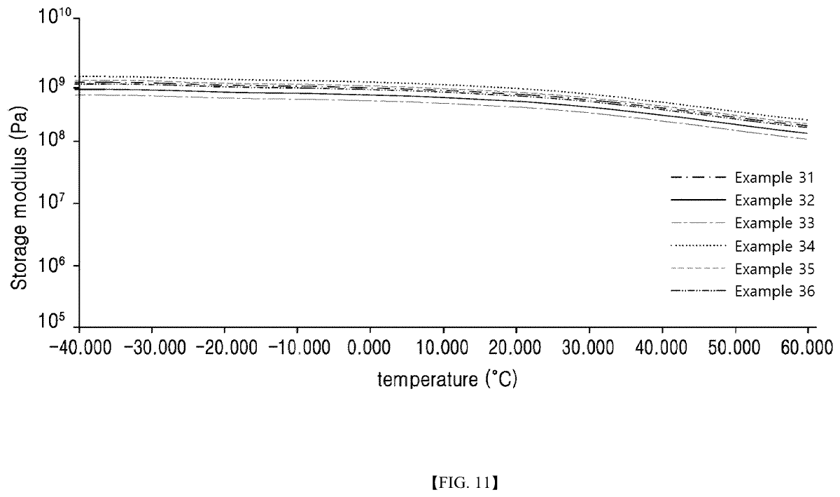

The thicknesses of the adhesive layers formed on one surface and the other surface of the elastic layer had the same thickness. The thickness of the adhesive layer used for each example is described in Table 1 below and FIGS. 6 to 11.

### Comparative Example 1: The Silicone-Based Adhesive Composition Used in the Examples was Dried and Cured to Form an Adhesive Layer Having a Thickness of 10 μm

### Evaluation Example: Measurement of Storage Modulus Value at Specific Temperature

The modulus was measured through dynamic mechanical analysis (DMA) for each example and the comparative example. Specifically, the storage modulus of each of samples for the examples and the comparative example was measured within a range of −50° C. to 100° C. using a DMA7100 model from HITACHI. The temperature increase rate was 5° C./min.

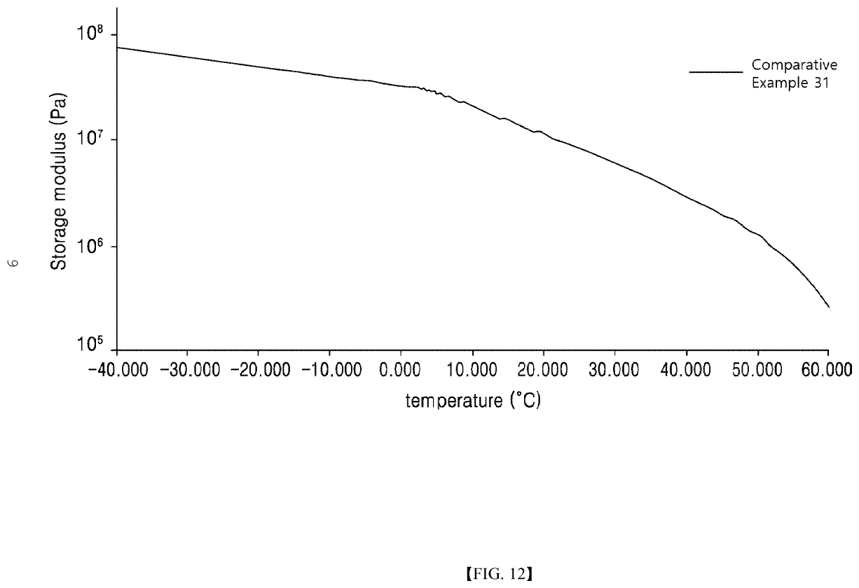

The measurement results at each measurement temperature for the examples and the comparative example are shown in Tables 1 and 2 below and FIGS. 6 to 12.

### Evaluation Example: Measurement of RSM Value at Specific Temperature

The SME and SMB values at specific temperature of the elastic layer and the adhesive layer applied to the multilayer sheet of each of Examples 2, 8, 14, 20, 26, and 32 were measured using a DMA7100 model from HITACHI. The measurement temperature range was set to −50° C. to 100° C., and the temperature increase rate was 5° C./min. The SME and SMB values at −40° C., −20° C., 0° C., 20° C., and 40° C. were measured, and the RSM values were calculated from the above values.

The SME values, the SMB values, and the RSM values measured at measurement temperature for each example are listed in Tables 3 and 4 below.

### Evaluation Example: Measurement of Adhesive Force for Each Adhesive Layer Thickness

The silicone adhesive composition used in each example for each preparation example was die-coated on a PET film (NRF grade from SKC) and dried and cured to obtain an adhesive layer. Drying and curing were performed at a temperature of 90° C. for 5 minutes. The thickness of the adhesive layer used for each manufacturing example is described in Table 3 below.

Subsequently, the adhesive force of the adhesive layer formed for each manufacturing example was measured. The adhesive force was measured in a T-peel mode using a QC-M1F UTM model from COMETECH, and the peeling speed was 300 mm/min.

The values of the adhesive force measured for each manufacturing example are shown in Table 5 below.

TABLE 1

| | | Total | Thickness | | Storage | Storage | Storage |
|---|---|---|---|---|---|---|---|
| | PEBA | thickness of | of | Thickness | modulus | modulus | modulus |
| | resin | multilayer | elastic | of adhesive | at | at | at |
| | product | sheet | layer | layer | −40° C. | −20° C. | 0° C. |
| | name | (μm) | (μm) | (μm) | (MPa) | (MPa) | (MPa) |
| Example 1 | 35R53 | 30 | 20 | 5 | 164 | 84 | 45 |
| Example 2 | 35R53 | 40 | 20 | 10 | 142 | 76 | 42 |
| Example 3 | 35R53 | 50 | 20 | 15 | 129 | 71 | 40 |
| Example 4 | 35R53 | 60 | 50 | 5 | 185 | 93 | 48 |
| Example 5 | 35R53 | 70 | 50 | 10 | 170 | 87 | 46 |
| Example 6 | 35R53 | 80 | 50 | 15 | 158 | 82 | 44 |
| Example 7 | 40R53 | 30 | 20 | 5 | 223 | 122 | 82 |
| Example 8 | 40R53 | 40 | 20 | 10 | 187 | 104 | 70 |
| Example 9 | 40R53 | 50 | 20 | 15 | 165 | 93 | 62 |
| Example 10 | 40R53 | 60 | 50 | 5 | 260 | 139 | 94 |
| Example 11 | 40R53 | 70 | 50 | 10 | 234 | 127 | 85 |
| Example 12 | 40R53 | 80 | 50 | 15 | 214 | 117 | 79 |
| Example 13 | 55R53 | 30 | 20 | 5 | 772 | 443 | 253 |
| Example 14 | 55R53 | 40 | 20 | 10 | 598 | 345 | 198 |
| Example 15 | 55R53 | 50 | 20 | 15 | 494 | 286 | 165 |
| Example 16 | 55R53 | 60 | 50 | 5 | 945 | 541 | 308 |
| Example 17 | 55R53 | 70 | 50 | 10 | 821 | 471 | 269 |
| Example 18 | 55R53 | 80 | 50 | 15 | 728 | 418 | 239 |
| Example 19 | 63R53 | 30 | 20 | 5 | 882 | 688 | 501 |
| Example 20 | 63R53 | 40 | 20 | 10 | 681 | 529 | 384 |
| Example 21 | 63R53 | 50 | 20 | 15 | 560 | 433 | 314 |
| Example 22 | 63R53 | 60 | 50 | 5 | 1083 | 848 | 618 |
| Example 23 | 63R53 | 70 | 50 | 10 | 940 | 734 | 534 |
| Example 24 | 63R53 | 80 | 50 | 15 | 832 | 648 | 472 |
| Example 25 | 70R53 | 30 | 20 | 5 | 1005 | 873 | 735 |
| Example 26 | 70R53 | 40 | 20 | 10 | 773 | 667 | 559 |
| Example 27 | 70R53 | 50 | 20 | 15 | 634 | 544 | 454 |
| Example 28 | 70R53 | 60 | 50 | 5 | 1237 | 1079 | 910 |
| Example 29 | 70R53 | 70 | 50 | 10 | 1072 | 932 | 785 |
| Example 30 | 70R53 | 80 | 50 | 15 | 947 | 822 | 691 |
| Example 31 | 72R53 | 30 | 20 | 5 | 913 | 827 | 748 |
| Example 32 | 72R53 | 40 | 20 | 10 | 704 | 633 | 569 |
| Example 33 | 72R53 | 50 | 20 | 15 | 578 | 516 | 462 |
| Example 34 | 72R53 | 60 | 50 | 5 | 1122 | 1022 | 926 |
| Example 35 | 72R53 | 70 | 50 | 10 | 972 | 883 | 799 |
| Example 36 | 72R53 | 80 | 50 | 15 | 861 | 779 | 703 |
| Comparative | — | — | — | 10 | 77 | 50 | 33 |
| Example 1 | | | | | | | |

TABLE 2

| | Storage | Storage | Storage | Storage |
|---|---|---|---|---|
| | modulus | modulus | modulus | modulus |
| | at 20° C. | at 40° C. | at 60° C. | at 80° C. |
| | (MPa) | (MPa) | (MPa) | (MPa) |
| Example 1 | 28 | 25 | 19 | 14 |
| Example 2 | 24 | 19 | 14 | 11 |
| Example 3 | 22 | 16 | 11 | 9 |
| Example 4 | 33 | 30 | 23 | 18 |
| Example 5 | 30 | 26 | 20 | 15 |
| Example 6 | 27 | 23 | 17 | 13 |
| Example 7 | 63 | 52 | 42 | 34 |
| Example 8 | 50 | 39 | 32 | 25 |
| Example 9 | 43 | 32 | 25 | 20 |
| Example 10 | 76 | 64 | 53 | 42 |
| Example 11 | 66 | 55 | 45 | 36 |
| Example 12 | 60 | 49 | 40 | 32 |
| Example 13 | 159 | 116 | 82 | 64 |
| Example 14 | 122 | 88 | 61 | 48 |
| Example 15 | 100 | 71 | 49 | 38 |
| Example 16 | 195 | 145 | 102 | 80 |
| Example 17 | 169 | 125 | 87 | 68 |
| Example 18 | 149 | 109 | 77 | 60 |
| Example 19 | 317 | 180 | 135 | 107 |
| Example 20 | 241 | 136 | 102 | 80 |
| Example 21 | 195 | 109 | 81 | 64 |
| Example 22 | 394 | 225 | 169 | 134 |
| Example 23 | 339 | 193 | 145 | 115 |
| Example 24 | 298 | 169 | 127 | 100 |
| Example 25 | 527 | 284 | 175 | 126 |
| Example 26 | 398 | 214 | 132 | 94 |
| Example 27 | 321 | 172 | 105 | 76 |
| Example 28 | 655 | 355 | 219 | 157 |
| Example 29 | 563 | 305 | 188 | 135 |
| Example 30 | 495 | 267 | 164 | 118 |
| Example 31 | 605 | 360 | 184 | 130 |
| Example 32 | 457 | 271 | 138 | 98 |
| Example 33 | 368 | 217 | 111 | 78 |
| Example 34 | 754 | 449 | 230 | 163 |
| Example 35 | 648 | 386 | 198 | 139 |
| Example 36 | 568 | 338 | 173 | 122 |
| Comparative | 12 | 2.9 | 0.24 | 0.005 |
| Example 1 | | | | |

TABLE 3

| | SM_{E} at | SM_{B} at | | SM_{E} at | SM_{B} at | | SM_{E} | SM_{B} at | |
|---|---|---|---|---|---|---|---|---|---|
| | −40° C. | −40° C. | RSM at | −20° C. | −20° C. | RSM at | at 0° C. | 0° C. | RSM at |
| | (MPa) | (MPa) | −40° C. | (MPa) | (MPa) | −20° C. | (MPa) | (MPa) | 0° C. |
| Example | 207 | 77 | 2.69 | 101 | 50 | 2.02 | 50.5 | 33 | 1.53 |
| 2 | | | | | | | | | |
| Example | 296 | 77 | 3.84 | 157 | 50 | 3.14 | 106 | 33 | 3.21 |
| 8 | | | | | | | | | |
| Example | 1120 | 77 | 1.43 | 639 | 50 | 12.78 | 363 | 33 | 11.00 |
| 14 | | | | | | | | | |
| Example | 1280 | 77 | 16.62 | 1010 | 50 | 20.20 | 735 | 33 | 22.27 |
| 20 | | | | | | | | | |
| Example | 1470 | 77 | 19.10 | 1280 | 50 | 25.60 | 1090 | 33 | 33.03 |
| 26 | | | | | | | | | |
| Example | 1330 | 77 | 17.27 | 1220 | 50 | 24.40 | 1100 | 33 | 33.33 |
| 32 | | | | | | | | | |

TABLE 4

| | SM_{E} at 20° C. | SM_{B} at 20° C. | RSM at | SM_{E} at 40° C. | SM_{B} at 40° C. | RSM at |
|---|---|---|---|---|---|---|
| | (MPa) | (MPa) | 20° C. | (MPa) | (MPa) | 40° C. |
| Example 2 | 36.7 | 12 | 3.06 | 35.8 | 2.9 | 12.34 |
| Example 8 | 88.3 | 12 | 7.36 | 75.9 | 2.9 | 26.17 |
| Example 14 | 232 | 12 | 19.33 | 173 | 2.9 | 59.66 |
| Example 20 | 470 | 12 | 39.17 | 269 | 2.9 | 92.76 |
| Example 26 | 784 | 12 | 65.33 | 425 | 2.9 | 146.60 |
| Example 32 | 902 | 12 | 75.17 | 539 | 2.9 | 185.86 |

TABLE 5

| | Thickness of | Adhesive | Adhesive force |
|---|---|---|---|
| | adhesive layer | force | per 1 μm |
| | (μm) | (N/inch) | (N/inch) |
| Manufacturing | 1 | 0.32 | 0.32 |
| Example 1 | | | |
| Manufacturing | 2 | 0.72 | 0.36 |
| Example 2 | | | |
| Manufacturing | 3 | 5.59 | 1.86 |
| Example 3 | | | |
| Manufacturing | 4 | 10.43 | 2.60 |
| Example 4 | | | |
| Manufacturing | 5 | 12.70 | 2.54 |
| Example 5 | | | |
| Manufacturing | 8 | 14.45 | 1.80 |
| Example 6 | | | |
| Manufacturing | 10 | 14.60 | 1.46 |
| Example 7 | | | |
| Manufacturing | 15 | 14.62 | 0.97 |
| Example 8 | | | |

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A multilayer sheet comprising an elastic layer and an adhesive layer disposed on a surface of the elastic layer, wherein a storage modulus of the multilayer sheet measured at 20° C. is 10 MPa to 2,000 MPa.

2. The multilayer sheet of claim 1, wherein the RSM (Relative Storage Modulus) value of the multilayer sheet measured at 20° C. according to Equation 1 below is 1 to 200:
RSM=SME/SMB [Equation 1]
where, in the Equation 1, SME is a storage modulus of the elastic layer and SMB is a storage modulus of the adhesive layer.

3. The multilayer sheet of claim 1, wherein an absolute value of the storage modulus of the multilayer sheet measured at 20° C. minus a storage modulus value of the multilayer sheet measured at 60° C. is 1,000 MPa or less.

4. The multilayer sheet of claim 1, wherein an absolute value of a storage modulus value of the multilayer sheet measured at −40° C. minus the storage modulus value of the multilayer sheet measured at 20° C. is 1,500 MPa or less.

5. The multilayer sheet of claim 1, wherein a storage modulus of the elastic layer measured at 20° C. is 10 MPa to 3,000 MPa.

6. The multilayer sheet of claim 1, wherein a storage modulus of the adhesive layer measured at 20° C. is 1 MPa to 50 MPa.

7. The multilayer sheet of claim 1, wherein an adhesive force of the adhesive layer after curing is 2 N/inch or more.

8. The multilayer sheet of claim 1, wherein an adhesive force per unit thickness (1 μm) of the adhesive layer after curing is 0.8 N/inch or more.

9. The multilayer sheet of claim 1, wherein a thickness of the multilayer sheet is 10 μm or more.

10. The multilayer sheet of claim 1, wherein the multilayer sheet further comprises an additional adhesive layer disposed on another surface of the elastic layer opposite to the surface of the elastic layer.

11. The multilayer sheet of claim 1, wherein the multilayer sheet further comprises a transparent layer disposed on the adhesive layer and a coating layer disposed on the transparent layer.

12. The multilayer sheet of claim 1, wherein the multilayer sheet further comprises a release film disposed on a surface of the adhesive layer.

13. The multilayer sheet of claim 12, wherein the release film comprises a release layer disposed on the surface of the adhesive layer and a release base layer disposed on a surface of the release layer.

14. The multilayer sheet of claim 1, wherein the elastic layer comprises polyether block amide comprising a rigid region and a soft region comprising polyether.

15. The multilayer sheet of claim 1, wherein the adhesive layer is selected from the group consisting of an acrylic-based adhesive layer, a urethane-based adhesive layer, and a silicone-based adhesive layer.

16. The multilayer sheet of claim 1, wherein the adhesive layer is a silicone-based adhesive layer.

17. The multilayer sheet of claim 1, wherein a thickness of the adhesive layer is more than 1 μm.

18. A method of preparing a multilayer sheet comprising:
preparing an elastic layer; and
laminating an adhesive layer on the elastic layer,
wherein the adhesive layer is prepared by: drying a silicone adhesive composition on the elastic layer to form a precursor layer; and curing the precursor layer to form the adhesive layer.

19. The method of claim 18, wherein the silicone adhesive composition comprises a silicone adhesive, a catalyst, and a solvent.

20. A multilayer electronic device comprising the multilayer sheet of claim 1 and a light emitting functional layer disposed under the multilayer sheet.
